(19) United States
(12) Patent Application Publication
(10) Pub. No.: US 2025/0353174 A1
(43) Pub. Date: Nov. 20, 2025

(54) ROBOTIC MATERIAL APPLICATION AND/OR REMOVAL FOR COMPONENTS

(71) Applicant: Canvas Construction, Inc., San Francisco, CA (US)

(72) Inventors: Maria J. Telleria, San Mateo, CA (US); Regis Vincent, San Mateo, CA (US); Sander Idelson, Oakland, CA (US); Shlok Singh Sobti, San Francisco, CA (US); Irene M. Davis, San Francisco, CA (US); Benjamin Seamus Barcklay, San Francisco, CA (US); Zelda Othenin-Girard, San Francisco, CA (US); Michael Charles Watkins, Berkeley, CA (US); Paul Mandel, San Francisco, CA (US); Anisa Nuanes, San Leandro, CA (US); Miles Flannery; John Magee, Orinda, CA (US)

(73) Assignee: Canvas Construction, Inc., San Francisco, CA (US)

(21) Appl. No.: 18/869,679

(22) PCT Filed: May 31, 2023
(86) PCT No.: PCT/US2023/067717

§ 371 Date: Nov. 26, 2024

Related U.S. Application Data
(60) Provisional application No. 63/347,494, filed on May 31, 2022.

(51) Int. Cl. B25J 9/16; B05B 13/04; B25J 11/00

(52) U.S. Cl. CPC B25J 9/1664; B05B 13/0431; B25J 9/1697; B25J 11/0075

(57) ABSTRACT

The present disclosure describes systems and methods for detecting data corresponding to an object and selectively affect, based at least in part on the data, a material on the object. In some embodiments, the data is, at least in part, used to selectively apply a material to the object, selectively avoid applying a material to the object; selectively remove at least a portion of a material from the object; and/or selectively avoid removing at least a portion of a material from the object.

### RELATED APPLICATIONS

This application claims priority to and receives the benefit of U.S. Provisional Application No. 63/347,494, titled “ROBOTIC MATERIAL APPLICATION AND/OR REMOVAL FOR COMPONENTS”, filed on May 31, 2022. The US Provisional application is hereby incorporated by reference in its entirety.

### BACKGROUND

Robotics and automated systems have an opportunity to improve manufacturing, fabrication, and construction. Tasks in these industries can be labor intensive and inefficient. Robotic systems can increase productivity and improve health and safety in these industries.

### BRIEF DESCRIPTION OF THE DRAWINGS

To provide a more complete understanding of the present disclosure and features and advantages thereof, reference is made to the following description, in conjunction with the accompanying Figures, wherein like reference numerals represent like parts.

FIGS. 1 and 2 are an exemplary perspective drawing illustrating an embodiment of a surface finishing system.

FIG. 3 is an exemplary block diagram illustrating systems of a surface finishing system.

FIG. 4 is an exemplary block diagram illustrating systems of a surface finishing system including a plurality of end effectors configured to couple to a robotic arm.

FIG. 5 illustrates a block diagram of a method of finishing surfaces in accordance with some embodiments.

FIGS. 6A, 6B, and 6C illustrate views of a building component.

FIGS. 7A, 7B, 7C, and 7D illustrate an example application process where a coating is applied to a joint.

FIGS. 8A, 8B, 8C, and 8D illustrate a wall assembly 800 including a plurality of substrate pieces 610A, 610B, 610C, 610D.

FIG. 9A illustrates a method for selectively applying a material to an object of interest.

FIG. 9B illustrates a method for selectively avoiding applying a material to an object of interest.

FIG. 9C illustrates a method for selectively removing a material from an object of interest.

FIG. 9D illustrates a method for selectively avoiding removing a material from an object of interest.

FIG. 10 illustrates a method for selectively applying a material to a seam associated with a component.

FIG. 11 illustrates a method for detecting data corresponding to a seam.

FIG. 12 illustrates a method for selectively applying a material to a seam.

FIG. 13 illustrates a simplified diagram of a surface finishing system comprising a spraying end effector.

FIG. 14 is a simplified diagram of a seam sprayed with a band of material.

FIGS. 15A, 15B, 15C, 15D, and 15E are diagrams of an assembly in which a surface finishing system applies material to the assembly.

FIG. 16 illustrates a system in which an end effector sprays a material onto a substrate.

FIG. 17 illustrates a system in which an end effector sprays a material onto a substrate.

FIGS. 18, 19, 20, and 21 illustrate various movements of an end effector to spray and terminate spraying a coating.

FIG. 22 portions of a coating sprayed to produce a full width of an end effector.

FIG. 23 portions of a coating sprayed to produce a partial width of an end effector.

FIG. 24 illustrates adjacent portions of two full width coatings.

FIG. 25 illustrates adjacent portions of two partial width coatings.

FIG. 26 illustrates a digital representation of a wall assembly generated by a planner.

FIG. 27 illustrates a digital representation of a component generated by a planner.

FIG. 28 illustrates a user interface for planning a task.

FIGS. 29 and 30 illustrate a user interface for viewing a plan and executing a task based on the plan.

FIG. 31 illustrates a user interface associated with a positioning process for execution of the plan.

FIGS. 32, 33, and 34 illustrate user interfaces associated with a seam detection algorithm.

FIGS. 35a and 35b are perspective drawings illustrating another embodiment of a surface finishing system.

FIG. 36 is a drawing illustrating another embodiment of a surface finishing system.

FIG. 37 depicts a block diagram illustrating an exemplary computing system that may be used in connection with various embodiments described herein, according to some embodiments of the disclosure.

FIG. 38 is a flow diagram illustrating a method for performing targeted application of material, according to some embodiments of the disclosure.

### DESCRIPTION OF EXAMPLE EMBODIMENTS OF THE DISCLOSURE

### Overview

In construction, one task is to create interior surfaces (e.g., building walls, ceilings, and floors, etc.). The task may include finishing wall surfaces so that they appear flat and can be painted. Building a wall includes building a wall assembly structure, applying material to fill in joints or seams, and sanding to create a smooth wall surface. One way to build a wall is to hang drywall panels, trowel or apply mud over the seams to fill in joints using hand tools, and sand excess material to create a smooth surface. Walls can be large and tall, which means that it can be physically straining for construction workers to use handheld tools to perform these tasks, especially troweling and sanding, for hours at a time. Construction workers can suffer physical injuries from this type of work. There is an opportunity to improve upon the process of building a wall by performing at least some of these tasks using a machine or a robot. The machine may perform these tasks autonomously or may be operated by a user. Making and using a machine or a robot to perform these tasks is not trivial.

It can be straightforward for a construction worker to visually locate, and identify types of seams on a wall, but it is not simple for a robot to do so. A robot may include sensors and a perception system to perceive features of the wall based on sensor data captured by the sensors. Computer vision and machine learning techniques may be used in a perception system to locate and identify types of seams.

It can be straightforward for a trained construction worker to apply mud to a targeted area using hand tools and to perform special motions with the hand tools to control and spread the amount of mud being applied to the targeted area. However, operating a robotic arm and end effector to spray material precisely in a targeted area and to perform motions to achieve specific surface profiles is not simple. Because the targeted area to be sprayed is determined by a perception system, the coordinates of the targeted area are determined in the coordinate system of the perception system. The location coordinates determined by the perception system may be translated to the coordinate system of the robot, such that a toolpath can be planned and executed by the robot. The planner of the robot may take into account certain constraints and limitations that may be specific to the robot when creating a toolpath. The planner of the robot may also determine an optimal toolpath for the task. The planner may take into account data generated by the perception system (e.g., type of seam), and other sensor data (e.g., environmental conditions).

Workers operating the robot may provide user input to the robot from time to time to correct information generated by the perception system, adjust toolpaths generated by the planner, and provide instructions to let the robot execute a task. The user interface may utilize the user input as feedback to improve the perception system (e.g., to train or calibrate machine learning models). The user interface may offer interactions that are user friendly, intuitive, and efficient.

Various aspects may cooperate together to achieve the technical task of applying material in a targeted area using a robotic system. The present disclosure describes systems and methods for detecting data corresponding to an object and selectively affect, based at least in part on the data, a material on the object. In some embodiments, the data is, at least in part, used to selectively apply a material to the object, selectively avoid applying a material to the object; selectively remove at least a portion of a material from the object; and/or selectively avoid removing at least a portion of a material from the object.

While some embodiments are described with respect to surface finishing, the techniques described herein may be applied to depositing insulation materials and/or fireproofing materials onto a surface. Some of the techniques are described with walls as an example. However, the techniques can also be applied to other types of building surfaces or structures, such as interior surfaces, exterior surfaces, building surfaces, ceilings, floors, etc. The techniques described herein may be applied to painting of a surface. The techniques described herein may be applied to fabrication and manufacturing.

### EXEMPLARY EMBODIMENTS

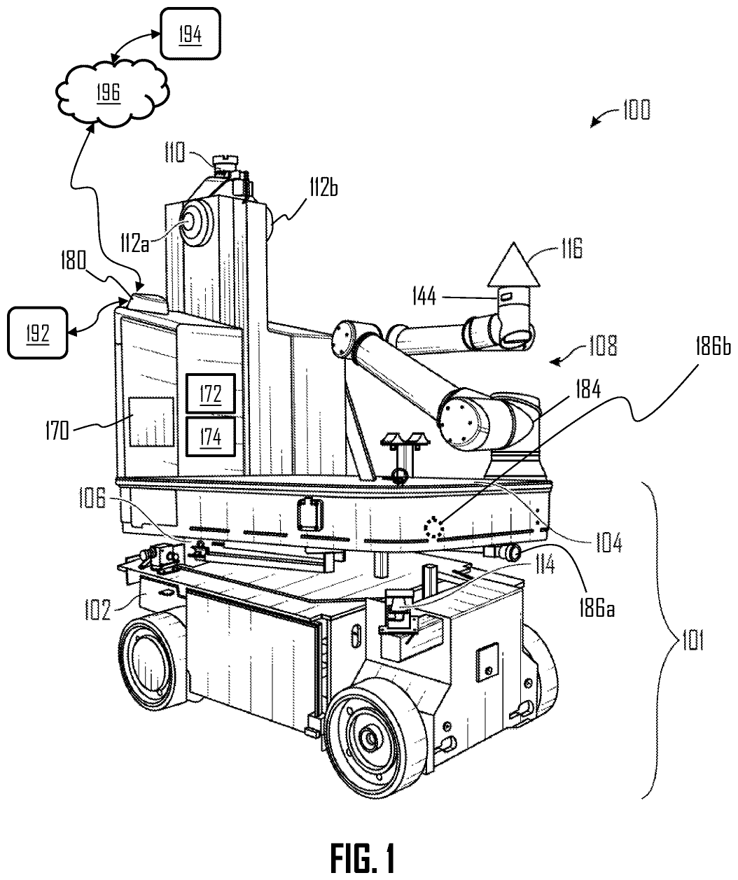

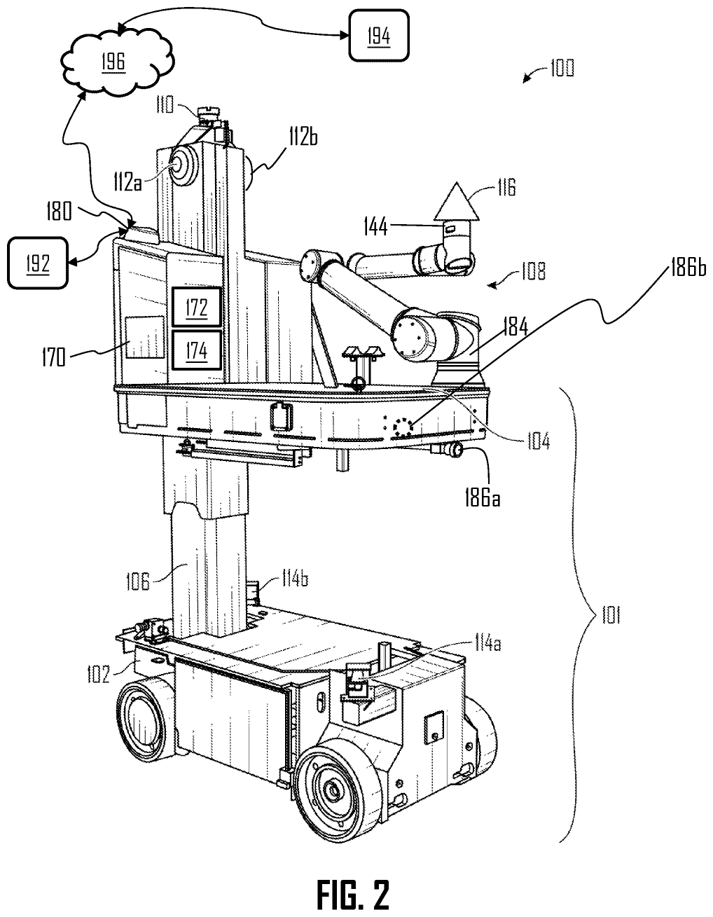

FIGS. 1 and 2 illustrate an exemplary surface finishing system 100 of the present disclosure. The surface finishing system 100 may be placed at a work site to perform surface finishing tasks. The surface finishing system 100 comprises one or more of: a base unit 101, a robotic arm 108, and an end effector 116. The base unit 101 can include one or more of, among other things, a positioning system 102, a support 104 coupled to the positioning system 102, and a lift system 106 that can control the height of the support 104. Robotic arm 108 can include a base end 184 and a distal end 144. The end effector 116 may be coupled to the distal end 144 of the robotic arm 108. The base end of robotic arm 108 can be coupled to the support 104.

The positioning system 102, the lift system 102, and the robotic arm 108 illustrate possible positioning mechanisms of a surface finishing system. Each positioning mechanism may have different degrees of freedom and/or limitations. The positioning mechanisms may cooperate to allow the end effector 116 to achieve a certain three-dimensional position within a work site. Other robotic positioning mechanisms are envisioned by the disclosure.

The positioning system 102 may change the (ground) position of the base unit 101, and can move the base unit 101. The positioning system 102 can be a coarse positioning system to mobilize the surface finishing system within a work site (enabling the end effector 116 to reach a region in space within the work site). The lift system 102 may change the height of support 104, such that the robotic arm 108 coupled to the support 104 may be able to reach higher regions in space within the work site. The robotic arm 108 may change a three-dimensional position of an end effector 116 within a three-dimensional space around the surface finishing system. The robotic arm can be a fine positioning system to mobilize the end effector 116 to a specific point in space within the work site.

The positioning system 102 may include a drive train system. As shown, the drive train system includes wheels. In some cases, the drive train system includes tracks. The drive train system is controllable to relocate the surface finishing system 100, on the ground, to and from different locations within an area. The drive train system may be controlled by a user. The positioning system 102 may navigate within the area autonomously (e.g., based on instructions or control signals generated by a computational planner).

In FIG. 1, lift system 106 is in an unextended position. In FIG. 2, the lift system 106 is in an extended position, lifting the support 104 upwards. Lift system 106 may lift the support 104 up and down to change the height of the support 104. Lift system 106 can aid the robotic arm 108 to reach a larger range of positions.

The robotic arm 108 can comprise any suitable robotic arm or positioning stage system, which can include pneumatic actuators, electric actuators, and the like. Examples of robotic arm 108 includes articulated arm, cartesian robot arm, cylindrical robot arm, delta robot arm, spherical robot arm, Selective Compliance Articulated Robot Arm (SCARA), etc. Robotic arm 108 may include links joined together by arm joints. Robotic arm 108 can change the position of end effector 116 on the distal end of robotic arm 108 within a three-dimensional workspace of robotic arm 108. The robotic arm 108 can have any suitable number of degrees of freedom. In some embodiments, the distal end of robotic arm 108, e.g., a wrist of robotic arm 108, may be able to rotate or revolve the end effector 116. In some embodiments, the distal end of robotic arm 108, e.g., a wrist of robotic arm 108, may be able to change the angle or direction of the end effector 116. Robotic arm 108 may be controlled by a user. Robotic arm 108 may change position within the workspace autonomously (e.g., based on instructions or control signals generated by a computational planner). Other types of fine positioning mechanisms that can change one or more of the position, rotational position, and angular direction of the end effector 116 are envisioned by the disclosure.

In some embodiments, the surface finishing system 100 can comprise one or more modular and/or multi-use end effectors 116, which can be configured for various drywalling, construction, manufacturing, fabrication, or other tasks. For example, as discussed herein, end effectors such as end effector 116 can be configured for substrate planning, substrate hanging, applying coating or joint compound to hung substrate, spraying, sanding the coating, painting, scraping, smoothing, applying tape, drilling, vibrating, measuring, applying pressure, sculpting, and the like. Such end effectors may be selectively coupled to or decoupled from the surface finishing system 100 to configure it with an end effector corresponding to a particular task. In some cases, end effector 116 may include a plurality of selectively triggerable/controllable end effectors (e.g., end effectors may have electronic triggers to turn on or off, and/or electronic controls to modulate settings of a given end effector).

The surface finishing system 100 may include sensors 110, 112a, 112b, 114a, 114b, 186a, and 186b. Sensors can generate sensor data for a perception system. Sensors can generate sensor data for a localization system.

Sensor 110 may include a distance/range sensor. Sensors 114a and 114b may include distance/range sensors. Examples of distance/range sensors may include, e.g., capacitive sensor, ultrasonics sensor, time-of-flight sensor, structured light sensor, light detection and ranging sensor (LIDAR), radio detection and ranging sensor (RADAR), etc. Sensors 110, 114a, and 114b may generate data that can measure the surface finishing system 100's distance from a wall. Sensors 110, 114a, and 114b may generate data that can assist a localization system to determine the surface finishing system 100's location within the worksite. Sensors 110, 114a, and 114b may generate data that can detect obstacles and/or other objects in the surroundings of the surface finishing system 100.

Sensors 112a and 112b may include a camera or imaging system (e.g., infrared camera, thermal camera, stereo cameras, structured light camera, etc.). In one example, sensors 112a and 112b are 180 degree field of view cameras. Sensors 112a and 112b can capture images and video of the surroundings (almost 360-degree field of view) of the surface finishing system 100. The images and video may offer situation awareness of the surface finishing system 100.

Sensors 186a and 186b may include a camera or imaging system (e.g., infrared camera, thermal camera, stereo cameras, structured light camera, etc.). Sensor 186b is shown in dashed lines since sensor 186b is located on a different side of support 104 not seen in the perspective view. Sensors 186a and 186b may be positioned and configured to capture images or video of a surface in front of sensors 186a and 186b (e.g., a wall in front of surface finishing system 100 or a wall next to a side of surface finishing system 100). Images captured by sensors 186a and 186b may be provided to a perception system and/or a localization system.

In some cases, surface finishing system 100 may include cameras or imaging systems having a field of view pointing in any suitable direction away from the surface finishing system 100. For example, surface finishing system 100 may include a camera or imaging system pointing upwards towards a ceiling. Surface finishing system 100 may include a camera or imaging system pointing downwards towards a floor. In some cases, surface finishing system 100 may include one or more cameras or imaging systems that can change its field of view (e.g., panning towards a different direction, zooming in or out, etc.).

Surface finishing system 100 may include one or more processors 172 and one or more non-transitory computer-readable media to store instructions and/or data. The instructions may be executed by the one or more processors 172 to implement one or more functionalities relating to sensor data processing, localization, perception, planning, and controls. The data may include data generated by the sensors. The data may include data generated by the one or more processors 172.

Surface finishing system 100 may include an output device 170. The output device 170 may include a display, such as touch-sensitive screen. The output device 170 may include an audio speaker. The output device 170 may output (e.g., display) status information about the surface finishing information. The output device 170 may output audible information (e.g., speech, sound, etc.) to a user operating the surface finishing system 100. The audible information may include status information about the surface finishing information. The audible information may include audio instructions from a remote operator at a remote user input system 194. In some cases, the output device 170 may receive user input and operate as an input device as well.

Surface finishing system 100 may include a network adapter 180. Network adapter 180 may offer wireless and/or wired connectivity to the one or more processors 172 for computing devices which are near the surface finishing system 100 or computing devices remote from the surface finishing system 100. Network adapter 180 may be communicably coupled to a local area network (not shown explicitly in the Figure). Network adapter 180 may be communicably coupled to a public communications network (e.g., cellular network 196).

In some embodiments, a local operator may operate and interact with the surface finishing system 100 using a user input system 192 that is near the surface finishing system 100 (e.g., at the same work site). The user input system 192 may be wirelessly communicably coupled with the one or more processors 172 via network adapter 180. The user input system 192 may be communicably coupled with the one or more processors 172 via a wired connection via network adapter 180. User input system 192 may be a mobile device, such as a smartphone or a tablet. User input system 192 may include user input interfaces and/or user output interfaces. User input system 192 may include a computing system. User input system 192 may have a graphical user interface. The graphical user interface may display information from systems such as perception system, localization system, planner, and controls. A local operator may provide user input using user input system 192. A local operator may send commands to the surface finishing system 100 (e.g., to start execution of a task, to control positioning system 102, etc.) using user input system 192.

In some embodiments, a remote operator may remotely operate and interact with the surface finishing system 100 using a remote user input system 194 that is remote from the surface finishing system 100 (e.g., not at the work site). The remote user input system 194 may be wirelessly communicably coupled with the one or more processors 172 via network adapter 180, over a cellular network 196 (e.g., 5G cellular network). The remote user input system 194 may include a computing system. The remote user input system 194 may receive sensor data captured by sensors of the surface finishing system 100. The remote user input system 194 may implement similar functionalities as the user input system 192. Remote user input system 194 may include user input interfaces and/or user output interfaces. Remote user input system 194 may have a graphical user interface. The graphical user interface may display information from systems such as perception system, localization system, planner, and controls. Graphical user interface may display video feeds from sensors 112a and 112b to monitor the surroundings of the surface finishing system. A remote operator may provide user input using remote user input system 194. A remote operator may send commands to the surface finishing system 100 (e.g., to start execution of a task, to control positioning system 102, etc.) using remote user input system 194. In some cases, the remote user input system 194 may implement expert functionalities such as debugging of the surface finishing system. In some cases, the remote user input system 194 may implement expert functionalities such as controls of the robotic arm 108 and/or lifting system 106.

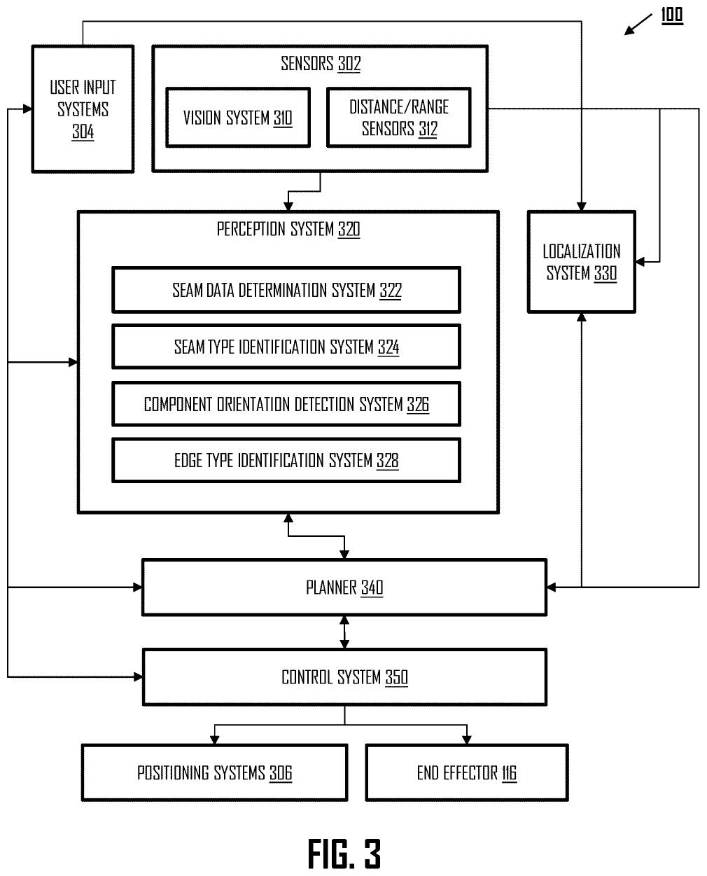

Turning to FIG. 3, FIG. 3 is a block diagram of a surface finishing system 100, which includes hardware and software (encoded as instructions stored on non-transitory computer-readable medium, the instructions executable by one or more processors) that make up the surface finishing system 100. The hardware may include sensors 302, one or more user input systems 304, one or more positioning systems 306, and one or more end effectors 116. The software may include perception system 320, localization system 330, (computational) planner 340, and control system 350.

The sensors 302 can comprise one or more suitable sensors including one or more visible spectrum camera, RADAR, LIDAR, sonar, a camera (e.g., infrared camera, thermal camera, stereo cameras, structured light camera, and the like), laser scanners, time-of-flight sensors, inertial measurement unit (IMU), and the like. Sensors 302 may include a vision system 310 (e.g., sensors that can capture images). Sensors 302 may include one or more distance/range sensors 312 (e.g., sensors that can detect presence, distance, and/or range of objects). The sensors 302 can comprise any suitable sensors in various embodiments including one or more sensors of humidity, temperature, air flow, laser curtains, proximity sensors, force and torque sensors, pressure sensors, limit switches, rotameter, spring and piston flow meter, ultrasonic flow meter, turbine meter, paddlewheel meter, variable area meter, positive displacement, vortex meter, pitot tube or differential pressure meters, magnetic meters, humidity sensor, conductivity sensor and depth or thickness sensors.

The one or more user input systems 304 may include one or more of: user input system 192, remote user input system 194, output device 170 of FIG. 1.

The one or more positioning systems 306 can comprise any suitable movement systems in various embodiments including one or more of an electric motor, pneumatic actuators, piezoelectric actuator, and the like. The one or more positioning systems 306 may move the surface finishing system 100, and in some cases, an end effector 116 of the surface finishing system. For example, in some embodiments the one or more positioning systems 306 may include one or more of the following: positioning system 102, lift system 106, and robotic arm 108.

As discussed herein, the one or more end effectors 116 can comprise various suitable devices, including a cutting device, hanging device, coating device, sanding device, painting device, vacuum device, sensing device, smoothing device, scraping device, taping device, and the like. Other suitable devices can be part of an end effector 116 and can be selected based on any desired task that the end effector 116 may be used for.

As discussed in more detail herein, the perception system 320 can receive sensor data from sensors 302. The perception system 320 may receive user input from one or more user input systems 304. The perception system 320 may include subsystems such as seam data determination system 322, seam type identification system 324, component orientation detection system 326, and edge type identification system 328. In some cases, the perception system 320 may determine seam data, including, e.g., location of seam, length of seam, endpoints of a centerline of a seam, orientation of a seam, type of seam, etc.

Localization system 330 may receive sensor data from sensors 302 to assist in determining location information of the base unit within a work site and/or the end effector 116 within a three-dimensional space. In some cases, localization system 330 may receive user input from user input systems 304.

Planner 340 may implement a computational planner that can determine (optimal and/or suitable) toolpaths for the one or more positioning systems 306 and end effector 116 to complete various tasks. Planner 340 may receive information from perception system 320 (e.g., location and type of seams). Planner 340 can receive information from one or more user input systems 304 specifying the task(s) to be performed. Planner 340 may receive information from one or more user input systems 304 that can impact the planner 340 finding a feasible and/or optimal tool path. Planner 340 may receive a map of the work site from an operator via one or more user input systems 304 Planner 340 may receive location information from localization system 330. Planner 340 may determine workspaces on which tasks are to be performed. Planner 340 may have knowledge of the coordinate system of the perception system 320 such that coordinates determined by the perception system 320 may be translated into the coordinate system of the planner 340 (i.e., coordinate system usable by control system 350 to control the one or more positioning systems 306). Planner 340 may have a kinematic model of the one or more positioning systems 306. Planner 340 may have a model of expected behavior/result of the end effector 116. Various models and/or constraints may impact the determination of feasible and/or optimal tool paths to successfully complete a task.

Control system 350 can receive toolpaths from planner 340 and generate control signals to drive the one or more positioning systems 306 and control the end effector 116 to perform various tasks. Such tasks can include, e.g., generating a plan to hang components, hanging components, generating a plan to apply coating to a component, selectively applying a coating to a component, selectively remove a coating from a component, sanding a coating, painting a component and/or coating, and the like. Accordingly, the control system 350 can drive the one or more positioning systems 306 and control the end effector 116 to perform various tasks, with some or all portions of such tasks being automated and performed with or without user interaction. In some cases, control system 350 may receive commands that override the control system 350 from one or more user input systems 304.

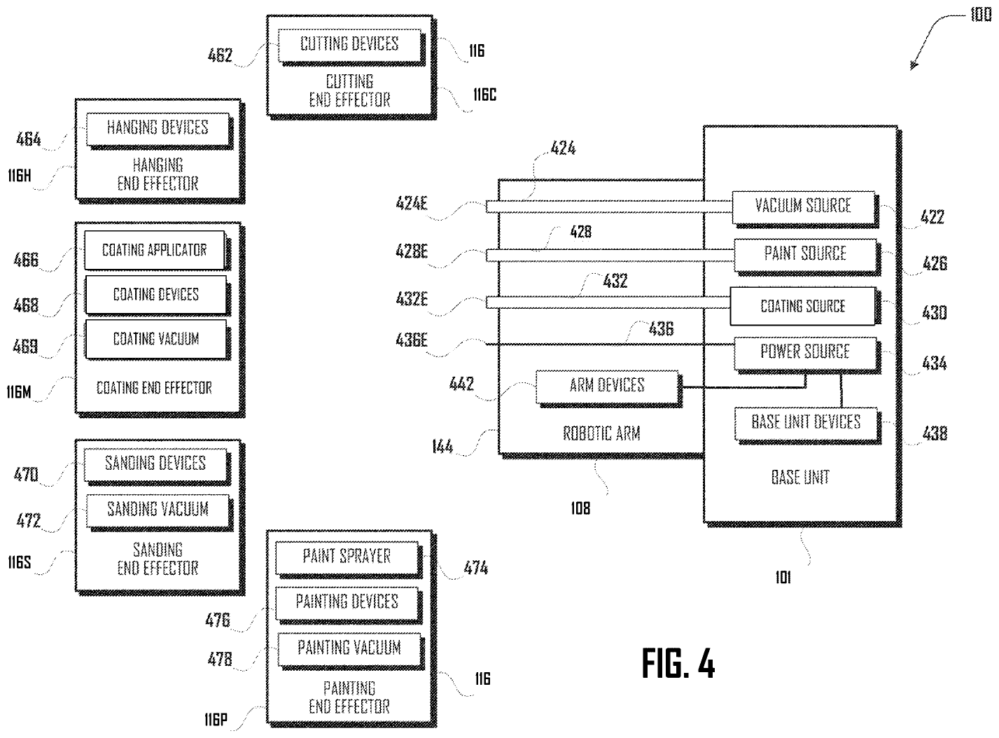

Turning to FIG. 4, FIG. 4 is a block diagram illustrating systems of a surface finishing system 100 that includes a base unit 101 coupled to a robotic arm 108 (an illustrative example of a positioning system) and including a plurality of end effectors 116 configured to couple to the distal end 144 of the robotic arm 108. In this example, the end effectors 116 include a cutting end effector 116C, a hanging end effector 116H, a coating end effector 116M, a sanding end effector 116S, and a painting end effector 116P.

As shown in FIG. 4, base unit 101 can comprise a vacuum source 422, a paint source 426, a coating source 430, a power source 434, and one or more base unit devices 438. In various embodiments, one or more of the vacuum sources 422, paint source 426, coating source 430, and power source 434 and provide resources to an end effector 116 coupled at the distal end 144 of the robotic arm 108 and/or to the robotic arm 108. For example, the vacuum source 422 can be coupled with a vacuum line 424 that extends via the robotic arm 108 to an end 424E, which can couple with an end effector 116 as discussed herein. The paint source 426 can be coupled with a paint tube 428 that extends via the robotic arm 108 to an end 428E, which can couple with an end effector 116 as discussed herein. The coating source 430 can be coupled with a coating tube 432 that extends via the robotic arm 108 to an end 432E, which can couple with an end effector 116 as discussed herein.

The power source 434 can be coupled with a power line 436 that extends via the robotic arm 108 to an end 436E, which can couple with an end effector 116 as discussed herein. Additionally, the power source 434 can provide power to arm devices 442 of the robotic arm 108 and to base unit devices 438 of the base unit 101. In various embodiments, the power source can comprise one or more batteries and/or can be configured to plug into wall receptacles at a work site. For example, a power cord can be coupled to the power source 434, which allows the surface finishing system 100 to be powered by local power at a worksite via a wall receptacle, generator, external batteries, or the like. However, in some embodiments, the surface finishing system 100 can be completely self-powered and can be configured to operate without external power sources at a worksite. In further embodiments, robotic arm 108 and/or end effectors 116 can comprise a separate power source that can be separate from the power source 434 of the base unit 101.

In various embodiments, the surface finishing system 100 can be configured to perform a plurality of tasks related to installing and finishing surfaces in construction. Joints are formed by abutting edges of adjacent components. For example, abutting edges of adjacent boards of substrate form a joint. The terms “joint” and “seam” are used interchangeably in the present disclosure.

In such embodiments, it can be desirable to have a base unit 101 and robotic arm 108 that can couple with and operate a plurality of different end effectors 116 to perform one or more tasks or portions of tasks related to drywalling. For example, the cutting end effector 116C, hanging end effector 116H, coating end effector 116M, sanding end effector 116S and painting end effector 116P can be selectively coupled with the robotic arm 108 at the distal end 144 to perform respective tasks or portions of tasks related to surface finishing.

The cutting end effector 116C can be selectively coupled at the distal end 144 of the robotic arm 108 and coupled with the power line 436 to power cutting devices 462 of the cutting end effector 116C. The surface finishing system 100 controls the cutting end effector 116C to cut building components or perform other cutting operations. The cutting end effector 116C comprises a cutting vacuum that is coupled to vacuum source 422 via the vacuum line 424 to ingest debris generated by cutting done by the cutting end effector 116C. In some examples, the surface finishing system 100 uses the cutting end effector 116C to selectively cut at least a portion of a material from an object and/or component.

The hanging end effector 116H can be selectively coupled at the distal end 144 of the robotic arm 108 and coupled with the power line 436 to power hanging devices 464 of the hanging end effector 116H. The surface finishing system 100 controls the hanging end effector 116H to hang building components, assist with hanging building components, or the like. In some examples, the surface finishing system 100 uses the hanging end effector 116H to selectively hang a material on an object and/or component.

The coating end effector 116M can be selectively coupled at the distal end 144 of the robotic arm 108 and coupled with the power line 436 to provide power to the coating devices 468 and/or coating applicator 466 of the coating end effector 116M. The surface finishing system 100 controls the coating end effector 116M to perform coating tasks associated with surface finishing, including application of joint compound to joints between building components and the like. Additionally, the coating end effector 116M can also be configured to apply joint tape, or the like. Additionally, the coating end effector 116M comprises a coating vacuum 469 that is coupled to vacuum source 422 via the vacuum line 424 to ingest excess coating generated by the coating end effector 116M. In some examples, the surface finishing system 100 uses the coating end effector 116M to selectively apply a coating to an object and/or component.

The sanding end effector 116S can be selectively coupled at the distal end 144 of the robotic arm 108 and coupled with the power line 436 to power sanding devices 470 of the sanding end effector 116S. The surface finishing system 100 controls the sanding end effector 116S to sand building components, coatings, paint, and the like. Additionally, the sanding end effector 116S comprises a sanding vacuum 472 that is coupled to vacuum source 422 via the vacuum line 424 to ingest debris generated by sanding done by the sanding end effector 116S. In some examples, the surface finishing system 100 uses the sanding end effector 116S to selectively sand at least a portion of a material from an object and/or component.

The painting end effector 116P can be selectively coupled at the distal end 144 of the robotic arm 108 and coupled with the power line 436 to power a paint sprayer 474 and/or painting devices 476 of the painting end effector 116P. The surface finishing system 100 controls the painting end effector 116P to paint building components, drywall, coating, or other surfaces. Additionally, the painting end effector 116P comprises a painting vacuum 478 that is coupled to vacuum source 422 via the vacuum line 424 to ingest excess paint spray generated by painting done by the painting end effector 116P. In some examples, the surface finishing system 100 uses the painting end effector 116P to selectively apply a paint to an object and/or component.

Although the example surface finishing system 100 of FIG. 4 is illustrated having five modular end effectors 116, other embodiments can include any suitable plurality of modular end effectors 116, with such end effectors 116 having any suitable configuration, and being for any suitable task or purpose. In further examples, the surface finishing system 100 can comprise a single end effector 116. which can be permanently or removably coupled to the robotic arm 108. Additionally, in some examples a given end effector 116 can be configured to perform a plurality of tasks. For example, in one embodiment, an end effector 116 can be configured for cutting, hanging, coating, sanding, and painting. Accordingly, the example of FIG. 4 should not be construed to be limiting on the wide variety of other embodiments that are within the scope and spirit of the present disclosure.

The surface finishing system 100 can include a computational planner (e.g., planner 340 in FIG. 3) which can utilize a map uploaded to the system 100 or created by the system 100 to determine toolpaths and/or tool parameters to achieve a desired coating application. The planner can create toolpaths off a global map of a room and then update these paths given updated local measurements once the end effector 116, robotic arm 108, and/or base unit 101 are in place. The planner can be informed by perception data (e.g., determined by perception system 320) on the flatness of the wall, user inputs, location of seams as specified by a layout planner or a scan of the room after the substrate was applied. The planner can determine toolpaths and/or tool parameters to enable the surface finishing system 100 to apply coating to smooth out joints, seams, low points, high points, and other features to create a visually flat wall.

For example, toolpaths can include information corresponding to, or used to determine, instructions for control system 350, which may generate control signals for one or more positioning systems 306 and end effector 116 to move to perform desired tasks, including applying coating, applying joint tape, and the like. Tool parameters can include various setting for components of the end effector 116 (e.g., setting for the coating applicator 466 and/or coating devices 468 of a coating end effector 116M), including a nozzle selection, a nozzle size setting, coating flow rate, velocity, fan bias angle, rotation, angle of flick, and the like as discussed in more detail herein.

The toolpaths and/or tool parameters can also be determined based on a desired or required finish for completed coating work or for a completed wall assembly. For example, areas of a wall or ceiling that are exposed to changing, harsh, or bright lights can receive a higher quality finish with tighter controls on tool planarity, tool overlaps, thickness and characteristics of compound applied, surface profile of the resulting coating, roughness rating/measurement of the resulting coating, and texture of the resulting coating.

The application of coating to a surface can inform how the surface is to be sanded, smoothed or polished to achieve a desired finish. For example, toolpaths and/or tool parameters generated during coating work can serve as inputs for generating toolpaths and/or tool parameters for sanding, which in some examples can enable sanding to be tuned according to the application of the compound, features, and compound characteristics such as how the compound was dried, compound type, compound hardness, and layers of compound applied.

For example, the surface finishing system 100 can determine toolpaths and/or tool parameters for performing coating work with a coating end effector 116M, and these determined toolpaths, tool parameters, and/or data associated thereto can be used to determine toolpaths and/or tool parameters for one or more sanding tasks to be performed by the surface finishing system 100 using a sanding end effector 116S.

Similarly, determining toolpaths and/or tool parameters for performing coating work with a coating end effector 116M can be based on various suitable inputs, including toolpaths, tool parameters, and/or the like associated with hanging substrate or applying insulation to a wall assembly on which the substrate is hung. For example, the surface finishing system 100 can determine toolpaths and/or tool parameters for performing substrate hanging with a hanging end effector 116H, and these determined toolpaths, tool parameters, and/or data associated thereto can be used to determine toolpaths and/or tool parameters for one or more coating tasks to be performed by the surface finishing system 100 using a coating end effector 116M.

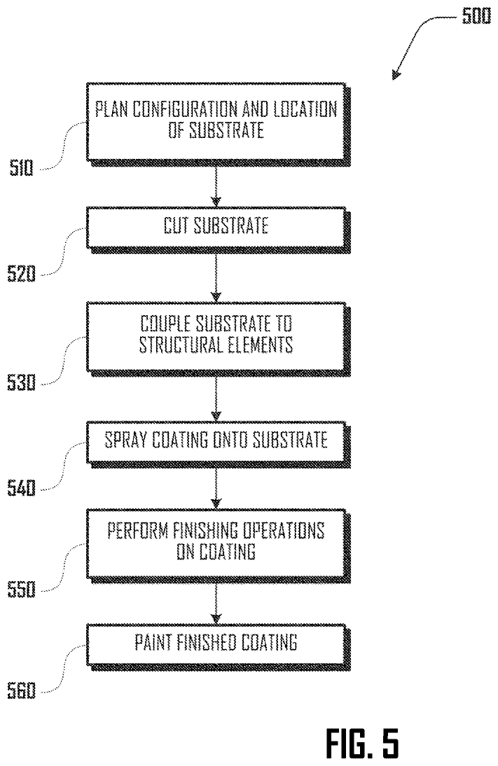

Turning to FIG. 5, FIG. 5 illustrates a method 500 of finishing a building component, which is performed in whole or in part by a surface finishing system 100 as discussed herein. The example method 500 or portions thereof can be performed automatically by the surface finishing system 100 with or without user interaction.

The method 500 begins at 510, where a configuration and location of a building component, such as a substrate piece, is planned. As discussed herein, in various examples a substrate can comprise one or more of mesh, paper, cloth surface, lath, buttonboard, rock lath, rainscreen, a porous surface, drywall board. For example, in some embodiments, a surface finishing system can be configured for automated scanning and mapping of a worksite (e.g., framing elements of a house or building) and automated planning of the shapes and sizes of substrate to be disposed at the worksite to generate walls, ceilings, and the like. Such scanning and mapping can include use of sensors 302 localization system 330 of FIG. 3) and the like. Planning of shapes and sizes of substrate can be based at least in part on the scanning and mapping and can be performed by the localization system 330 of FIG. 3 of the surface finishing system 100 or other suitable device which can be proximate or remote from the surface finishing system 100. In some embodiments, such planning can be based at least in part on building plans or maps that were not generated by the surface finishing system 100.

The method 500 continues to 520, where substrate pieces are cut. Such cutting can be based at least in part on the scanning, mapping and planning discussed above. Additionally, such cutting can be performed by the surface finishing system 100 at a worksite (e.g., via a cutting end effector 116C) or can be performed by a system remote from the worksite and generated substrate pieces can be delivered to the worksite.

At 530, cut pieces of substrate can be hung at the worksite, including hanging on studs, beams, posts, wall plates, lintels, joists, and the like, to define walls, ceilings and the like. Screws, nails or other suitable fasteners can be used to hang the substrate. In some embodiments, the surface finishing system 100 can be configured to hang substrate including positioning the substrate and coupling the substrate in a desired location. In some examples, the surface finishing system 100 can be configured to assist a user in hanging substrate, including holding the substrate and/or tools in place while the user fixes the substrate pieces in place. In various examples, a hanging end effector 116H can be used for such substrate hanging.

At 540, coating work can be performed on the hung substrate. For example, a coating such as plaster, stucco, parex, gypsum, or the like (known also as “mud”) can be applied to seams or joints between adjacent pieces of substrate, over the substrate, and/or can be applied over fasteners such as screws or the like. In various examples, a coating end effector 116M can be used to perform such coating work.

At 550, finishing operations can be performed on the coatings. In some examples, the finishing operations include smoothing the coating before it hardens. In some examples, the finishing operations include sanding the coating after it hardens. For example, where a wet joint compound is applied to a hung substrate, the joint compound can be allowed to harden (e.g., dry, set, cure, and the like) and can then be sanded by a sanding end effector 116S of a surface finishing system 100. In various examples, sanding can be performed to smooth the coating to generate a planar or otherwise consistent profile on the pieces of substrate. At 560, the finished coating can be painted. For example, in various examples, a painting end effector 116P of a surface finishing system 100 can be used to paint the coating.

In some embodiments, after spraying the coating onto the substrate, the coating can be worked into the substrate using trowels, edges, and other suitable tools. This process can be done manually or using the surface finishing system 100. The tools may be powered using electricity, compressed air, hydraulics or a combination of these. The tools may be instrumented with sensors to measure humidity, pressure, viscosity, roughness, force, and light reflectivity. After the coating has hardened, it may be treated with manual or powered tools to create the desired finish, texture, and material properties. The tools may be used by workers or the surface finishing system 100 can use the tools to affect the surface. The surface finishing system 100 may use tools such as sanders, polishers, powered trowels, or the like. The tools or automated system(s) 100 may utilize vacuum systems to capture particles or fumes. The sensors on the tools may be used to control the force, pressure, and speed with which the tools are used on the surface. The surface finishing system 100 may utilize sensors to capture the finish or texture of the coating at different stages. Cameras, laser systems, texture analyzers, reflectivity sensors, conductivity measurements, and/or other contact or non-contact systems may be used to determine the surface finish of the coating and be used as feedback for the tools and process.

The coating can be combined with paint, tint, pigment, additives, accelerants, activators, or the like before, during, and/or after application. The coating can also be subsequently sprayed with a paint or sealant to create the finished surface after the coating is applied to a substrate or other surface. Tinted plaster, gypsum, or the like can be sprayed to create a colored surface in a single coating. Other additives can also be mixed into the coating to control curing or drying time, surface finish, material properties, and the like. Material properties can include hardness, reflectivity, sound insulation, thermal insulation, fire rating, texture, finish, and the like. A variety of approaches may be used to accelerate setting, curing, and/or drying of the coating. For example, light, temperature, or air exposure may be employed to achieve the acceleration. In addition, an additive such as a chemical accelerant, chemical activator, curing agent, or catalyst can be added to the coating before, during, and/or after application of the coating to the substrate.

Chopped fibers and other particles can be added to the coating before, during, and/or after application to a substrate to create a composite. The fibers can act to increase the strength of the coating and can create mechanical bonds to the substrate materials. The fibers can be added directly into the mixture that can be pumped to a nozzle or such fibers can be applied at a nozzle. The substrate can be covered in fibers or features that the coating can attach to.

Tools such as a curing light, heater, or blower can be mounted on the same tool as the sprayer to follow the delivery or can be mounted on another suitable portion of the surface finishing system 100 or separately therefrom. Additionally, surface finishing system 100 can be used after spraying to move such a heater, blower, light, or other suitable tool or device over the substrate or surface. The velocity of the base unit 101 can be controlled to set a given work time for each of the tools. The curing, setting, and/or drying time can also be controlled by mixing powdered material with a volatile solvent instead of water.

Although the method 500 of FIG. 5 relates to hanging and finishing surfaces, it should be clear that other hanging and finishing methods can similarly be employed by the surface finishing system 100, including methods related to hanging particle board, plywood, sheet rock, laminate, tile, wall boards, metal sheeting, lath and the like. Similarly, the methods can be used with different coatings including plaster, polymer coatings, cement, stucco, organic coatings, and the like. Accordingly, method 500 of FIG. 5 should not be construed to be limiting.

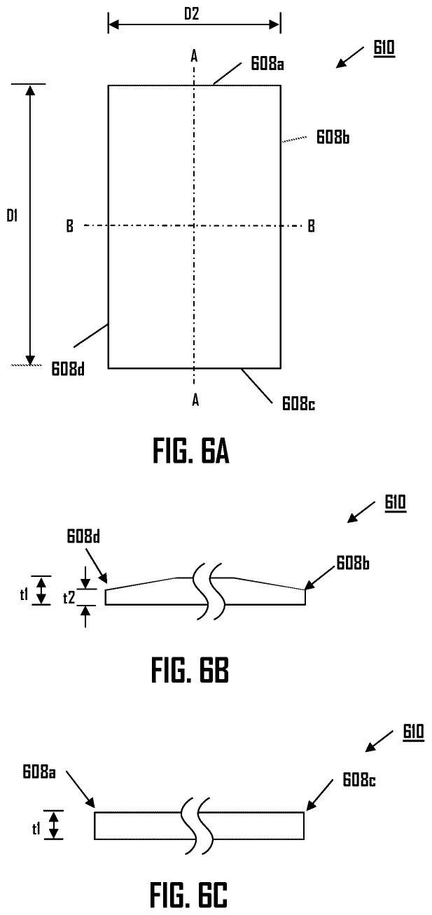

FIGS. 6A, 6B, and 6C illustrate various views of a building component, which in this case is a substrate 610. FIG. 6A illustrates a front view of substrate 610. FIG. 6B illustrates a cross-section cut through substrate 610 along line B-B. FIG. 6C illustrates a cross-section cut through substrate 610 along line A-A. The substrate 610 comprises a first dimension D1 and a second dimension D2 and edges 608a, 608b, 608c, and 608d. The substrate has a thickness of t1. Substrate 610 is rectangular. The first dimension D1 and the second dimension D2 are perpendicular to one another. The first dimension D1 is larger than the second dimension D2. The edges 608b and 608d are tapered edges, which taper from the thickness t1 down to t2. The edges 608a and 608c are flat edges, are of a constant thickness t1 and do not taper.

Substrate 610 can be installed in one or more orientations. When attached to studs, the substrate 610 may be attached in a first orientation where the first dimension is oriented at a first angle or a second orientation where the first dimension is oriented at a second angle. For example, when substrate 610 is attached to vertically oriented studs, the substrate 610 may be placed in either a vertical orientation or a horizontal orientation. In the vertical orientation, the first dimension D1 is vertically aligned. In the horizontal orientation, the first dimension D1 is horizontally aligned.

In other embodiments, a profile of the edges 608a, 608b, 608c, and 608d may vary. For example, the location of tapered edges and flat edges may be swapped (e.g., the edges 608b and 608d are flat edges and the edges 608a and 608c are tapered edges). In still other examples, all of the edges 608a, 608b, 608c, and 608d may be of a single type. In an embodiment, all of the edges 608a, 608b, 608c, and 608d are tapered edges. In another embodiment, all of the edges 608a, 608b, 608c, and 608d are flat edges.

Joints are formed by abutting edges of adjacent components, such as substrate 610. For example, abutting edges of adjacent boards of substrate form a joint. The terms “joint” and “seam” are used interchangeably in the present disclosure. A tapered joint (also known as a “factory” joint) is formed by abutting tapered edges of adjacent components. A tapered joint creates a valley in which coating material can be applied to create a level surface relative to a face of the substrate 610. A butt joint is formed by abutting flat edges of adjacent components. In contrast to tapered joints, butt joints lack a formal valley in which a coating material can lie to create a level surface. Creating the appearance of flatness is easier for tapered joints than it is for butt joints because the valley in tapered joints can hide much of the coating material. In contrast, for butt joints, much of the material extends beyond the plane of the surface of the substrate. A mixed joint (also known as a bastard joint) is formed by abutting a tapered edge and a flat edge of adjacent components. Mixed joints have only a portion of the valley for the coating material.

During coating work, surface finishing system 100 can apply a layer of coating material to joints that may have a thickness that is greater than is conventionally manually applied by human workers to allow for a sanding system (e.g., a sanding end effector 116S) to sand down the compound to a desired plane. For example, in some examples, manual joint compound application mud can be profiled to taper from high points. The surface finishing system 100 can apply a thicker layer than normal, enabling a sanding system to sand down high points to be level to the adjacent surfaces.

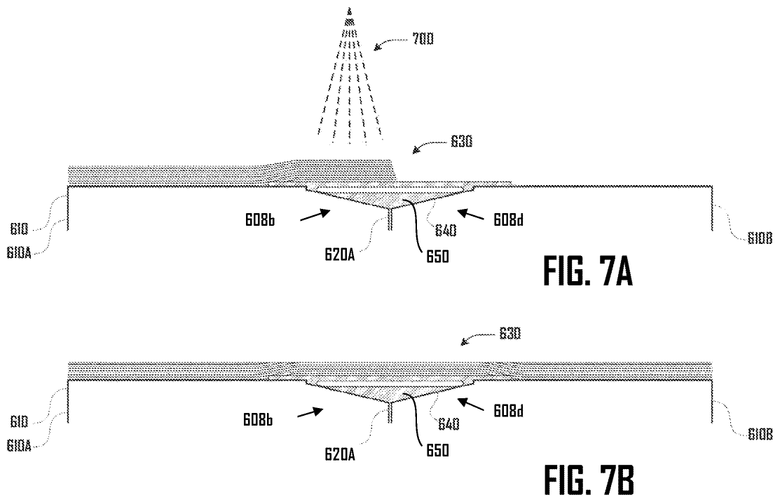

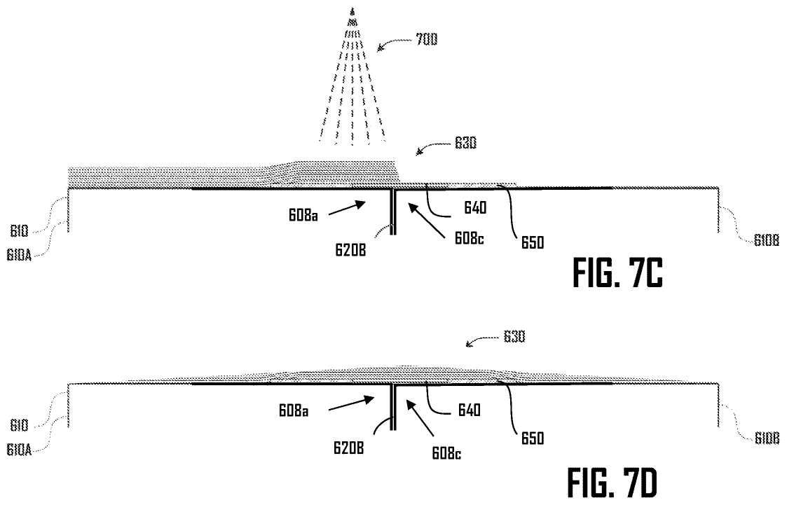

FIGS. 7A, 7B, 7C, and 7D illustrate an example coating application process where a coating is applied to a joint. FIGS. 7A and 7B illustrate an example coating applied to a tapered joint 620A formed by abutting edges 608b and 608d of substrates 610A and 610B, respectively. FIGS. 7C and 7D illustrate an example coating applied to a butt joint 620B formed by abutting edges 608a and 608c of substrates 610A and 610B, respectively. Joint tape 640 may be embedded in a coating material 650, which attaches the joint tape 640 to the respective substrates. An end effector generates a coating spray 700 to apply the coating 630 in one or more layers to the joints. Such an application process can be performed by the surface finishing system 100 in various embodiments. The thickness of the coating 630 being applied to the pieces of substrate defining the joints can allow for a sanding system to be used to sand back portions of coating 630 to hide the joints, joint tape, and/or a high point therein.

In FIGS. 7A and 7B, the thickness of the coating 630 being applied to the pieces of substrate 610A, 610B defining the tapered joint 620A can allow for a sanding system to be used to sand back high portions of coating 630 to hide the joint tape 640 and create a level surface. The high portions of coating 630 can be caused by the tapered joint 620A, the joint tape 640, feature, raised stud, defect, or any combination thereof. The tapered joint 620A creates a valley in which the coating 630 can be applied to create a level surface relative to a face of the substrate 610.

In FIGS. 7C and 7D, the thickness of the coating 630 being applied to the pieces of substrate 610A, 610B defining the butt joint 620B can allow for a sanding system to be used to sand back portions of coating 630 to hide the joint tape 640, smooth an exposed surface of the coating, and/or create the appearance of a level surface. While butt joints lack the valley of a tapered joint, butt joints are given the appearance of flatness by creating a slow continuous slope to hide the high point.

In some examples, creating the appearance of flatness is different for tapered joints and the butt joints. In tapered joints, the valley is recessed relative to a face of the substrate and, therefore, can hide much of the coating material 650. In butt joints, much of the material extends beyond the face of the substrate of the substrates 610A and 610B. Thus, the high points (relative to the face of the substrate) are often higher on butt joints than on tapered joints. These high points can impede the appearance of flatness. Thus, the high points are sanded back towards the face of the substrate to improve the appearance of flatness. As the height of the high point increases (e.g., for butt joints), systems and methods disclosed herein may increase the width of the coating. The increased width provides more distance over which to gradually taper the material from the high point to the face of the substrate and, thereby, improve the appearance of flatness.

The substrate 610 and sprayed coating 630 can be used as a stand-alone wall coating system for single-coat applications or as part of a multi-coat wall coating system. A multi-coat wall coating system can comprise two or more layers of the same or different materials applied manually and/or with automation. This can allow for an automated application of a coating 630 to the substrate 610 with desirable structural properties to be followed by an application of a coating 630 with desirable aesthetic finishing properties.

In some embodiments, a substrate 610 can have coating 630 applied as shown in FIGS. 7A, 7B or via other suitable methods as discussed herein and/or the substrate 610 can be pre-impregnated with a coating material 630 prior to hanging or it may be impregnated by one coating followed by a second material. The coating 630 can be impregnated with a material similar to pre-impregnated composites. The coating material 630 in the substrate 610 can be activated or wetted by spraying a liquid material over it the coating material 630 to convert the impregnated material into a rigid coating. The coating 630 may be electrostatically charged and the substrate 610 grounded to accelerate coating particles towards the substrate 610 and improve adhesion and/or reduce overspray of the coating 630. The coating 630 can have additives to facilitate electrostatic charging.

In some embodiments, an end effector 116 can use a coating 630 that comprises fibers in addition to, or as an alternative to, joint tape 640. One or more perception systems can be used to identify seams 620 between substrate pieces 610 and data from such perception systems can be used to guide an end effector 116 during application of the coating. The end effector 116 can also be guided using the planner's map of the surface which is located on the environment using relevant features such as markers, corners, openings, or the like.

Surface finishing systems of the present disclosure may selectively apply, selectively avoid applying, selectively remove and/or selectively avoid removing material. In addition and/or in combination with such activities, the surface finishing systems can perform other tasks including, e.g., planning, spraying a material (e.g., joint compound, paint, insulation) cutting substrate, hanging substrate, painting, and the like. The following U.S. patents describe some surface finishing systems including U.S. Pat. No. 10,513,856 issued on Dec. 24, 2019 and titled “Automated drywall planning system and method”; U.S. Pat. No. 10,526,799 issued on Jan. 7, 2020 titled “Automated drywall cutting and hanging system and method”; U.S. Pat. No. 10,822,814 issued on Nov. 3, 2020 titled “Automated drywall mudding system and method”; U.S. Pat. No. 10,718,119 issued on Jul. 21, 2020 titled “Automated drywall sanding system and method”; U.S. Pat. No. 11,499,325 issued on Nov. 15, 2022 titled “automated drywall painting system and method”; U.S. Pat. No. 10,697,188 issued on Jun. 30, 2020 titled “Automated drywalling system and method”; U.S. Pat. No. 10,870,996 issued on Jun. 30, 2020 titled “Automated insulation application system and method”; U.S. Pat. No. 10,577,810 issued on Mar. 3, 2020 titled “Automated wall finishing system and method”, each of which is hereby incorporated herein by reference in its entirety and for all purposes.

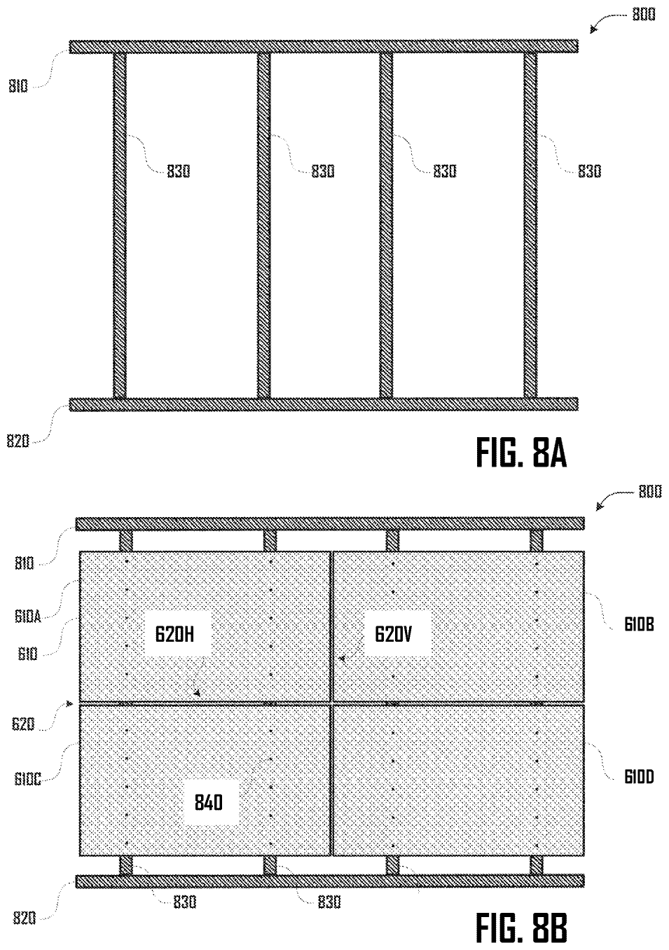

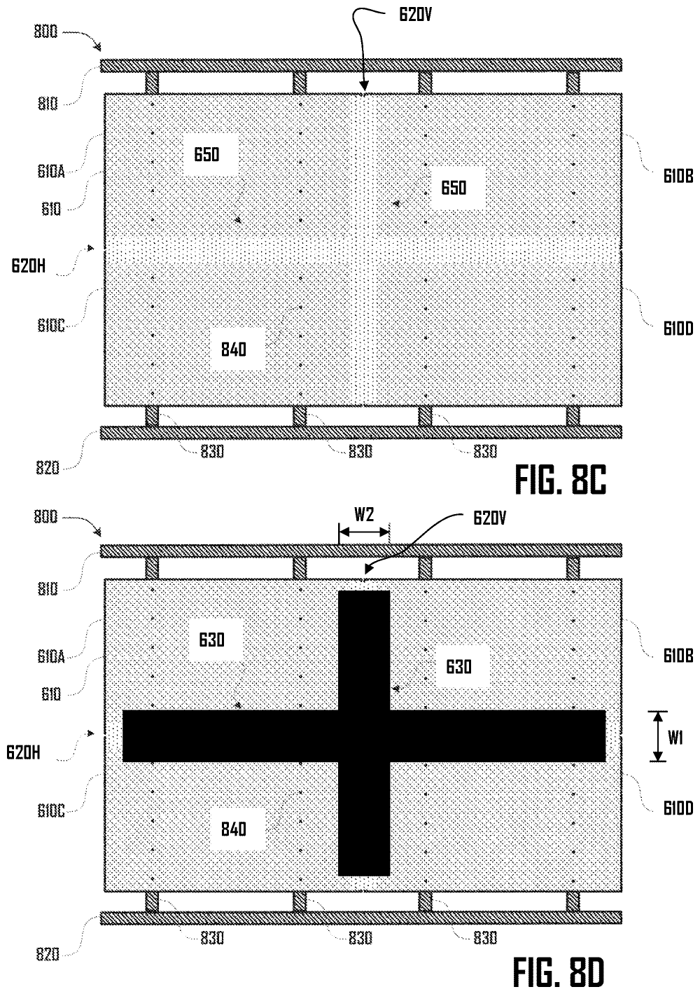

FIGS. 8A, 8B, 8C, and 8D illustrate a wall assembly 800 including a plurality of substrate pieces 610A, 610B, 610C, 610D. The wall assembly 800 comprises a header 810 and footer 820, with a plurality of studs 830 extending therebetween as shown in FIG. 8A. As shown in FIG. 8B, the substrate pieces 610A, 610B, 610C, 610D are coupled to the studs 830 via a plurality of fasteners 840 (e.g., screws, nails, and the like) that extend through each of the substrate pieces 610A, 610B, 610C, 610D and into the studs 830. Adjacent ones of the substrate pieces 610A, 610B, 610C, 610D create seams including a vertical seam 620V and a horizontal seam 620H as indicated in FIGS. 8B, 8C, and 8D. FIG. 8C illustrates a coating 650 coating seams 620H and 620V. In some examples, the coating 650 imbeds a joint tape (e.g., similar to the joint tape 640 that of FIGS. 7A, 7B, 7C, and 7D).

As illustrated in FIG. 8D, a surface finishing system as disclosed herein can selectively apply a coating 630 to the seams 620H and 620V leaving portions of the substrate pieces 610a, 610b, 610c, 610d without the coating 630. The coating 630 covers the coating material 650. The coating 630 is applied in bands around the seams 620H and 620V. The coating 630 covering the seam 620H lies in a band of width W1 and is approximately centered about the centerline of the seam 620H. The coating 630 covering the seam 620V lies in a band of width W2 and is approximately centered about the centerline of the seam 620V. In each case the coating 630 is not applied outside of a threshold around the seam. A surface finishing system may execute various processes and methods to apply the coating 630.

Applying the coating 630 in bands around the seams 620H and 620V can include, e.g., applying the coating within a threshold distance of a centerline of each of the seams 620H and 620V. For the seam 620H, the threshold distance is half of the width W1. For the seam 620V, the threshold distance is half of the width W2. In each case, the coating 630 is not applied outside of the respective threshold distances from the centerlines of the seams 620H and 620V.

In some examples, the width of the coating 630 may be set to different values based on the type of seam, orientation of the seam, orientation of the one or more components, an edge type, quality of the seam, desired level of finish, coating composition, and combination thereof. For example, the coating 630 may be applied to butt seams in a band of width W1 and applied to tapered seams in a band of width W2, where W1 is greater than W2. Unlike tapered seams, butt seams do not create a valley in which the coating 630 can sit and lie flat with the substrate. The larger width for butt seams provides more space to gently taper the coating 630 to create the appearance of flatness at the butt seam.

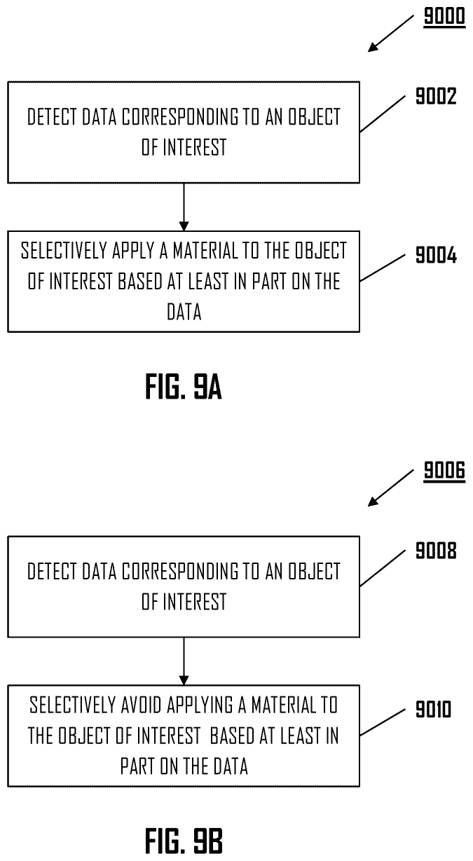

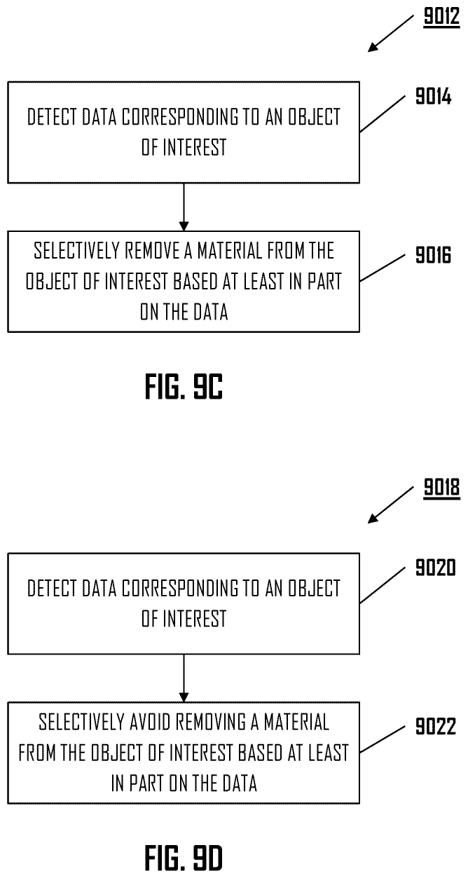

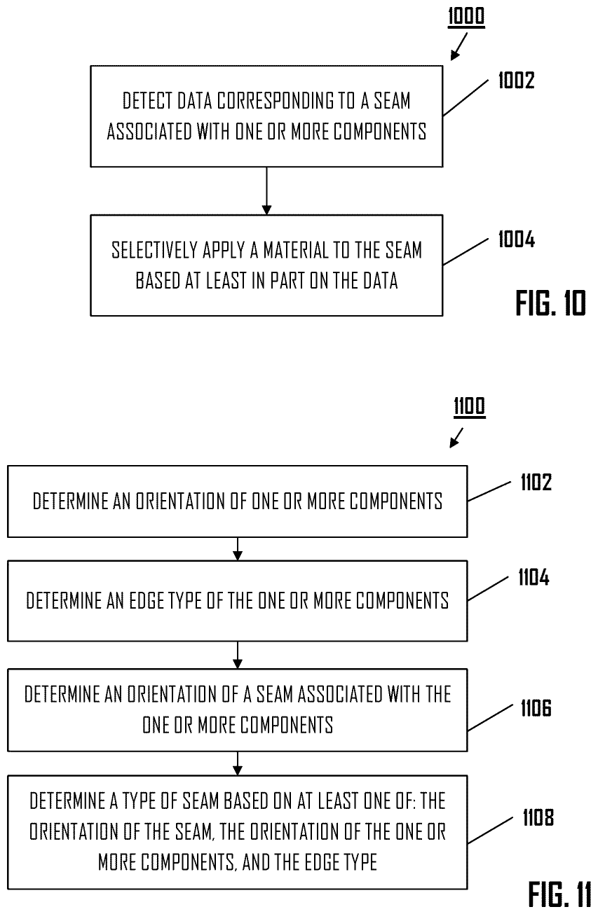

FIG. 9A illustrates method 9000 for selectively applying a material to an object of interest. Method 9000 includes 9002, detecting data corresponding to an object of interest, and 9004, selectively applying the material to the object of interest based at least in part on the data. At 9002, the data can be generated based on perception data received from a perception system. At 9004, an end effector selectively applies the material to the object of interest. Such selective application of material may include the end effector maintaining a threshold distance around the object of interest in which the end effector applies the material. The end effector may only apply the material to the object of interest (e.g., inside the threshold distance) while also avoiding applying the material to other objects that are not the object of interest (e.g., outside the threshold distance).

FIG. 9B illustrates method 9006 for selectively avoiding applying a material to an object of interest. Method 9006 includes 9008, detecting data corresponding to an object of interest, and 9010, selectively avoiding applying the material to the object of interest based at least in part on the data. At 9008, the data are generated based on perception data received from a perception system. At 9010, an end effector avoids application of the material to the object of interest. Such selective avoidance may include the end effector maintaining a threshold distance around the object of interest in which the end effector does not apply the material. The end effector may only avoid application of the material to the object of interest (e.g., inside the threshold distance) while also applying the material to other objects that are not the object of interest (e.g., outside of the threshold distance).

FIG. 9C illustrates method 9012 for selectively removing a material from an object of interest. Method 9012 includes 9014, detecting data corresponding to an object of interest, and 9016, selectively removing the material from the object of interest based at least in part on the data. At 9014, the data can be generated based on perception data received from a perception system. At 9016, an end effector may remove the material from the object of interest. Such selective removal may include the end effector maintaining a threshold distance around the object of interest in which the end effector removes the material. The removal may include removing only a portion of the material of the object while leaving remaining portions intact. The end effector may remove the material from the object of interest (e.g., inside the threshold distance) while also avoiding removing the material from other objects that are not the object of interest (e.g., outside of the threshold distance).

FIG. 9D illustrates method 9018 for selectively avoiding removing a material from an object of interest. Method 9018 includes 9020, detecting data corresponding to an object of interest, and 9022, selectively avoiding removing the material from the object of interest based at least in part on the data. At 9020, the data can be generated based on perception data received from a perception system. At 9022, an end effector may avoid removal of the material from the object of interest. Such selective avoidance may include the end effector maintaining a threshold distance around the object of interest in which the end effector does not remove the material. The end effector may only avoid removal of the material to the object of interest (e.g., inside the threshold distance) while also removing the material from other objects that are not the object of interest (e.g., outside of the threshold distance).

An object of interest can include an object in its entirety and/or one or more features of the object. For example, some surface finishing systems disclosed herein may execute the method or methods to a building component and/or a building assembly. For example, the object of interest may include a wall, a stud, a header, a substrate, a window, a door, a ceiling, a floor, a corner bead, a surface treatment (e.g., a tile, a wallpaper, a paint, and the like), an electrical receptacle, a pipe, a conduit, a fixture, an appliance, an attachment, and any other component or assembly. Features may include an opening, a recession, a projection, a seam, a frame, an orientation, a corner, a type (e.g., selected from one of multiple variations of the object of interest), or any other feature. For example, the object of interest may include a component that has a particular feature such as: a component of a specific type and a specific orientation, a seam between two or more components, an opening in a component, a first component mounted on a second component, a first component extending from and/or recessed into on a second component, and the like.

The methods of methods 9000, 9006, 9012, and 9018 of FIGS. 9A, 9B, 9C, and 9D can be executed separately, in combination with one another, and/or in combination with other methods. A surface finishing system as disclosed herein may execute only method 9000, only method 9006, only method 9012, only method 9018, or a combination of two or more methods of methods 9000, 9006, 9012, and 9018. For example, the surface finishing system may execute method 9000 to selectively apply material to a first component of an assembly and simultaneously execute method 9006 to selectively avoid applying the material to a second component of the assembly. A surface finishing system may execute method 9000 to selectively apply material to a component and later execute method 9012 to selectively remove a portion of the material from the component. Moreover, either or both of the methods 9000 and 9006 may be executed with other methods or logic.

FIG. 10 illustrates method 1000 for selectively applying a material to a seam associated with a component. Method 1000 includes 1002, detecting data corresponding to a seam associated with one or more components, and 1004, selectively applying the material to the seam based at least in part on the data. At 1002, the data can be generated based on perception data received from a perception system. At 1004, an end effector applies the coating on a first portion of the one or more components adjacent to the seam and simultaneously avoids applying the coating on a second portion of the one or more components which are at a threshold distance away from the seam.

FIG. 11 illustrates method 1100 for detecting data corresponding to a seam. The method may be performed by a perception system (e.g., perception system 320 of FIG. 3), using sensor data generated by sensors of the surface finishing system. In some cases, the data may be provided by a user via a user input system. The method 1100 comprises 1102, determining an orientation of one or more components; 1104, determining an edge type of the one or more components; 1106, determine an orientation of a seam associated with the one or more components; and 1108 determining a type of seam based on at least one of: the orientation of the seam, the orientation of the one or more components, and the edge type.

The components can include building components and or building assemblies. For example, the components can include a substrate (e.g., such as substrate 610 of FIGS. 6A-C) or an assembly having multiple pieces of substrate. The orientations can include one of a plurality of orientations: vertical orientation, horizontal orientation, angled orientation (e.g., a first angle or a second angle), and the like. The edge type defines a profile of one or more edges of the components. In some examples, the edge type comprises a location of a tapered edge on the components, and/or a location of a flat edge of the components. The type of seam comprises one or a plurality of types such as a butt seam, a tapered seam, or a mixed seam.

At 1102, various approaches may be employed to determine the orientation of one or more components. For example, a vision system may capture an image including a portion of the seam. In some embodiments, a component orientation detection system (e.g., component orientation detection system 326 of FIG. 3) may perform feature extraction on the image such as edge extraction, segmentation, and template matching, to determine the orientation of one or more components. In some embodiments, a component orientation detection system may include a machine learning model (e.g., classification algorithm) that can identify the orientation of the one or more components based on the image. The machine learning model can output the orientation of the components. In a further example, a user input system receives an input (e.g., virtual or physical key press on a user interface) that indicates the orientation of the components. A user may select a button identifying one of a plurality of orientations of the components. Such user input data may be used alone or in combination with other data to determine the orientation of the components. In some embodiments, the component orientation detection system may determine the edges of the components based on the image. Determining the edges may include determining the location of the edges in the image and the length of the edges. Determining the edges may include determining the orientation of the edges (e.g., vertical or horizontal). From the edges, the component orientation detection system may infer the orientation of the components based on the lengths of the edges. For example, if the horizontal edges of a component are longer than the vertical edges of a component, then the component is in a horizontal orientation. If the vertical edges of a component are longer than the horizontal edges of a component, then the component is in a vertical orientation.

At 1104, various approaches may be employed to determine the edge type of the one or more components. For example, a vision system may capture an image including a portion of the seam. In some embodiments, an edge type identification system (e.g., edge type identification system 328 of FIG. 3) may include a machine learning model (e.g., classification algorithm) that may be used to identify the edge type. In some embodiments, the image having at least a portion of the seam may be captured using structured light or a scanning laser. An edge type identification system may process the image to determine whether the lines in the grid pattern are characteristic of a certain edge type. In another example, a scanning system (e.g., a laser scanner) may capture a surface profile of the area having the seam. The edge type identification system may process the surface profile to determine the edge type. In a further example, a user input system may receive an input (e.g., virtual or physical key press on a user interface) that indicates the edge type. Such user input data may be used alone or in combination with other data to determine the orientation of a seam. In some embodiments, the edge type identification system may infer the edge type based on the orientation of the component and/or whether the edge is a longer edge of a component. For example, the longer edges of a component may always be tapered, and the shorter edges of a component may always be flat. If a component is oriented horizontally, the horizontal edges may be the longer edges. Thus the horizontal edges may be tapered and the vertical edges may be flat. If a component is oriented vertically, the vertical edges may be the longer edges. Thus the vertical edges may be tapered and the horizontal edges may be flat. Accordingly, the edge type identification system may determine the edge type based on whether the orientation of the component and/or whether the edge is a longer edge of a component.

At 1106, various approaches may be employed to determine data about a seam associated with the one or more components. The data about the seam may include an orientation of the seam. The data about the seam may include a bounding box around the location of the seam. The data about the seam may include a centerline or points representing a centerline of a seam. The data about the seam may include a length of a seam. For example, a vision system (e.g., within a perception system) may capture an image including a portion of the seam. In some embodiments, a seam data determination system (e.g., seam data determination system 322 of FIG. 3) may include performing feature extraction on the image such as edge extraction or segmentation to determine the orientation of the seam. In some embodiments, a seam data determination system may include a machine learning model (e.g., classification algorithm) may be used to identify the orientation of the seam. The machine learning model may output the orientation of the seam. In some examples, the machine learning model outputs seam data. Seam data can comprise at least one of: a bounding box around the seam, a label identifying an orientation of the seam, a first confidence score associated with the bounding box, a second confidence score associated with the label, and a third confidence score associated with the bounding box and the label. The bounding box around the seam has a first dimension and a second dimension, where the first and second dimensions are perpendicular to one another. In some examples, the first dimension is larger than the second dimension. In such examples, the orientation of the seam is the vertical orientation when the first dimension is vertically aligned when the orientation of the seam is the vertical orientation. Likewise, the orientation of the seam is the horizontal orientation when the first dimension is horizontally aligned. Systems of the present disclosure may use the seam data to determine at least two coordinates corresponding to points along a centerline of the seam. For example, the coordinates may correspond to endpoints of a centerline of the seam. A user input system may receive an input (e.g., virtual or physical key press) that indicates the orientation of the seams. For example, a user may select a button identifying one of a plurality of orientations for the seams. Such user input data may be used alone or in combination with other data to determine the orientation of a seam. In some embodiments, the seam data determination system may determine data about the seam based on outputs of the component orientation detection system and/or the outputs of the edge type identification system.

At 1108, various approaches may be employed to determine a type of seam based on at least one of: the orientation of the seam, the orientation of the one or more components, and the edge type.

For example, 1108 may include determining, based on the edge type and the orientation of the components, that tapered edges are vertically oriented and flat edges are horizontally oriented. In such a case, the seam is determined, e.g., by rules or decision tree of a seam type identification system, to be a tapered seam based on the orientation of the seam being vertical (vertical edges were determined to be tapered edges) and the seam is determined, e.g., by the rules or decision tree of the seam type identification system, to be a flat seam based on the orientation of the seam being horizontal (horizontal edges were determined to be flat edges). In some embodiments, a vision system (e.g., within a perception system) captures an image including a portion of the seam. In some embodiments, a seam type identification system (e.g., seam type identification system 324 of FIG. 3) may include a machine learning model (e.g., classification algorithm) that may be used to identify and output the seam type of the seam. Joint tape can be colored, dyed or marked so that it is easier for a perception system and/or machine learning model to identify the joint tape. Tapes having different identifying features (e.g., color, textures, images, barcodes, or the like) can be used in some embodiments to provide information to a surface finishing system about the identity or characteristics of a specific joint or other feature of the components. For example, butt joints can be covered with a first color tape, tapered joints can be covered with a second color tape, and factory joints can be covered with a third color tape. A user input system may receive an input (e.g., virtual or physical key press) that indicates the type of seam. For example, a user may select a button identifying one of a plurality of types for the seam. Such user input data may be used alone or in combination with other data to determine the type of the seam. In some embodiments, the seam type identification may determine seam type based on outputs of the component orientation detection system and/or the outputs of the edge type identification system.

Seam data and/or seam type information may aid a planner in producing a toolpath (and parameters) that can selectively apply a material to a seam accurately and appropriately.

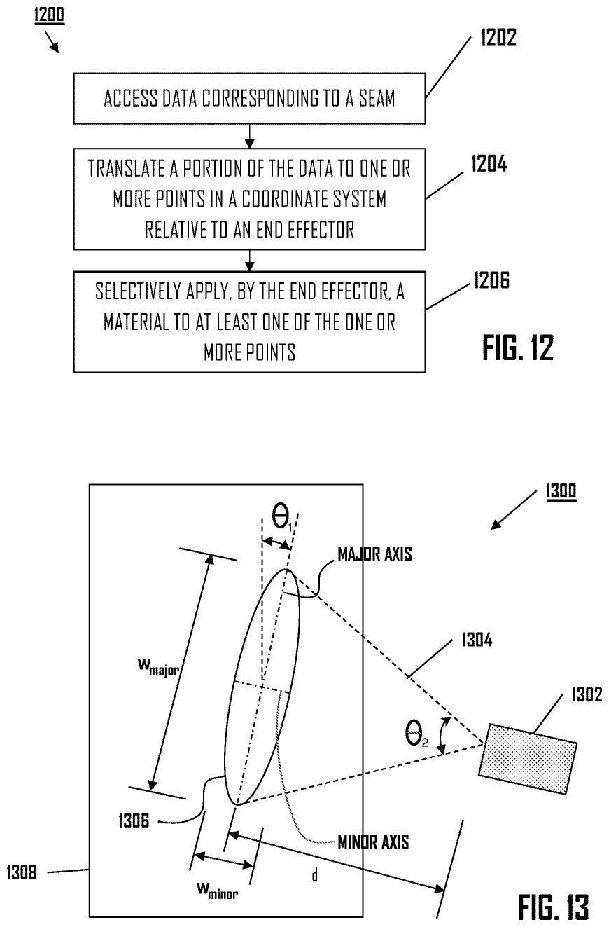

FIG. 12 illustrates method 1200 for selectively applying a material to a seam. The method 1200 comprises 1202, accessing data corresponding to a seam; 1204, translating a portion of the data to one or more points in a coordinate system relative to an end effector; and 1206, selectively applying, by the end effector, a material to at least one of the one or more points.

At 1202, various approaches may be employed to access the data corresponding to the seam. The data may be accessed from a perception system. For example, the data may be received from a machine learning model, a classification algorithm, image processing algorithm, surface profile processing algorithm, point cloud processing algorithm, decision tree or logic system, and/or a user input. The data may be stored on one or more non-transitory computer-readable media. The data may include pixels of an image that are labeled as a portion of a seam between substrates.

At 1204, various approaches may be employed, e.g., by a planner, to translate a portion of the data to points in a coordinate system relative to a surface finishing system. For example, image pixels may be translated to coordinates relative to system components of a surface finishing system. A memory can store a coordinate system relative to the surface finishing system. The memory stores the location of various system components (e.g., a base unit, a support, a base end of a robotic arm, a distal end of the robotic arm, an end effector coupled to the robotic arm, a perception system, a camera, and the like) of the surface finishing system 100 in the coordinate system. The coordinate system relates the locations of the system components to one another. Thus, positional data generated by any of the system components may be translated to the coordinate system. For example, a camera may capture an image of the seam. A perception system may collect positional data relating to an assembly in which the seam is located to the coordinate system (in terms of a coordinate system of the perception system). The surface finishing system translates at least one pixel of the image to a point in the coordinate system based on a known location of the camera in the coordinate system. When the pixel corresponds to the seam, any coordinates generated therefrom correspond to points along the seam. In some embodiments, a planner may translate two-dimensional coordinates obtained by the perception system (e.g., coordinates on an image) using a matrix transformation to obtain three-dimensional coordinates in the coordinate system usable by the positioning systems (e.g., coordinates in the coordinate system of the positioning systems of a robot).

At 1206, various approaches may be employed to selectively apply, by the surface finishing system, a material to the points. A planner may generate the toolpath, which can include parameters for the end effector, that may yield targeted application of material to the points. For example, an end effector of the surface finishing system applies the coating within a threshold distance of the points and simultaneously avoids applying the coating outside of the threshold distance of the points. The end effector sprays the material in a region having a shape such as an elliptical shape, a linear shape, a rectangular shape, and the like. Various parameters of the end effector of other components driving the end effector are modified to set parameters of the sprayed material (e.g., width, thickness, length, and the like). As an example, the end effector can be oriented at various angles to set the width of the sprayed material. The speed of the end effector while spraying, in part, sets the thickness of the material. For example, the speed of the end effector can increase while spraying to taper down the thickness of the material; the speed of the end effector can decrease while spraying to taper up the thickness of the material. Such parameters of the end effector may be varied individually or in combination to achieve target parameters of the sprayed material. In some examples, the end effector executes a combination of dynamically varied parameters of the end effector to achieve a complex movement.

In some cases, the end effector executes differently varied parameters over different sprays (e.g., passes or coatings) to achieve a target surface profile of the material being sprayed. Different sprays or coatings may have the same centerline. Different sprays or coatings may have centerlines which are offset but parallel to each other.

In some cases, the spraying end effector may have multiple spray tips. Two or more spray tips may be selectively used to spray material at the same time (with or without overlapping spray patterns) to achieve a target surface profile. One or more spray tips may spray material at the same time at different angles or orientations to achieve a target surface profile.

One or more sensors of the surface finishing system may be used to detect or sense a surface profile (e.g., of a surface without a coating, of a surface after a coating has been applied using a first set of parameters) and use the data as feedback to guide the parameters of different sprays. The data may be used as feedback to selectively use one or more spray tips (e.g., selectively activate electronic triggers of the spray tips) in a set of spray tips to achieve a target surface profile.

FIG. 13 illustrates a simplified diagram of a surface finishing system 1300 comprising a spraying end effector 1302. The spraying end effector 1302 is located a distance, d, from a surface 1308 while spraying material in a fan 1304 that has a spread angle, Θ₂, and produces a spray pattern 1306. The spray pattern 1306 is generally elliptical in shape. The spray pattern 1306 has a major axis and a minor axis. The major axis has a corresponding major width, wₘₐⱼₒᵣ, measured along the major axis. The minor axis has a corresponding minor width, wₘᵢₙₒᵣ, measured along the minor axis. The spraying end effector 1302 can be rotated about an axis that passes through a center of the orifice and the center of the fan 1304; such rotation about the axis biases the spray pattern 1306 at a fan bias angle, Θ₁. When the spraying end effector 1302 is rotated at an angle of 0 or 360 degrees, the width of the material sprayed from the spraying end effector 1302 is equal to the major width, wₘₐⱼₒᵣ. When the material is sprayed at an angle between 0 and 360 degrees (e.g., non-zero, and not 360 degrees), the width of the material sprayed from the spraying end effector 1302 is less than the major width, wₘₐⱼₒᵣ. An orientation spraying end effector 1302 may be rotated or revolved by a distal end of a robotic arm to achieve a specific fan bias angle.

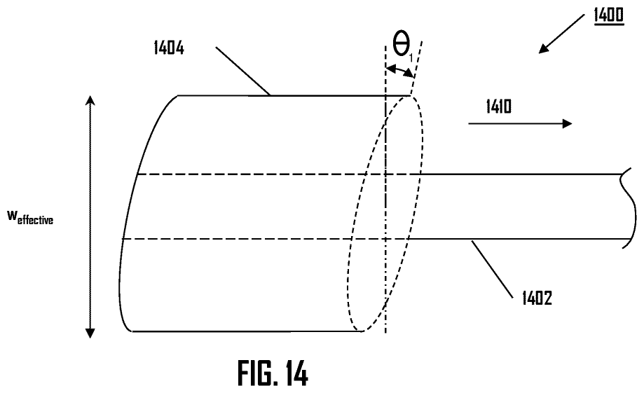

For example, FIG. 14 is a simplified diagram 1400 of a seam 1402 sprayed with a band of material 1404 by the spraying end effector 1302 when rotated at the fan bias angle, Θ₁. The spraying end effector 1302 moves in the direction indicated by arrow 1410 while spraying the band of material 1404. Because the spraying end effector 1302 is rotated, the spray pattern 1306 is biased at the fan bias angle, Θ₁ and the effective width, w_{effective}, of the spray pattern 1306 is less than the major width, wₘₐⱼₒᵣ. The thickness and surface profile of the material deposited by the spraying end effector 1302 varies based on, among other things, speed at which the spraying end effector 1302 moves in the direction indicated by arrow 1410 while spraying the material. For example, increasing the speed of the spraying end effector 1302 reduces the thickness of the sprayed material and vice versa. In another example, the surface profile of the material deposited by the spraying end effector 1302 may vary based on the fan bias angle, Θ₁. A flow rate of the spraying end effector 1302 can depend on the amount of pressure driving the material through the spraying end effector 1302, material viscosity, a size of the orifice on the spraying end effector 1302, and an amount of wear around the orifice (e.g., more wear can increase the size of the orifice). In some examples, the wear around the orifice is modeled and included in the calculation of the volumetric flow rate. Parameters of the sprayed material (e.g., effective width, thickness, and surface profile) are based on parameters of the spraying end effector 1302 (e.g., distance to the sprayed surface, spread angle of the fan, rotation of the end effector). Thus, surface finishing systems of the present disclosure vary the parameters of the spraying end effector 1302 to achieve desired parameters of the sprayed material by varying. As used herein, surface profile refers to varying thicknesses of a material (e.g., a thickness dimension) along a line or over a two-dimensional area. Surface profile of the band of material 1404 may not be uniform in thickness. Surface profile of the band of material 1404 may have different thicknesses. Surface profile of the band of material 1404 may have bumps or discontinuities.

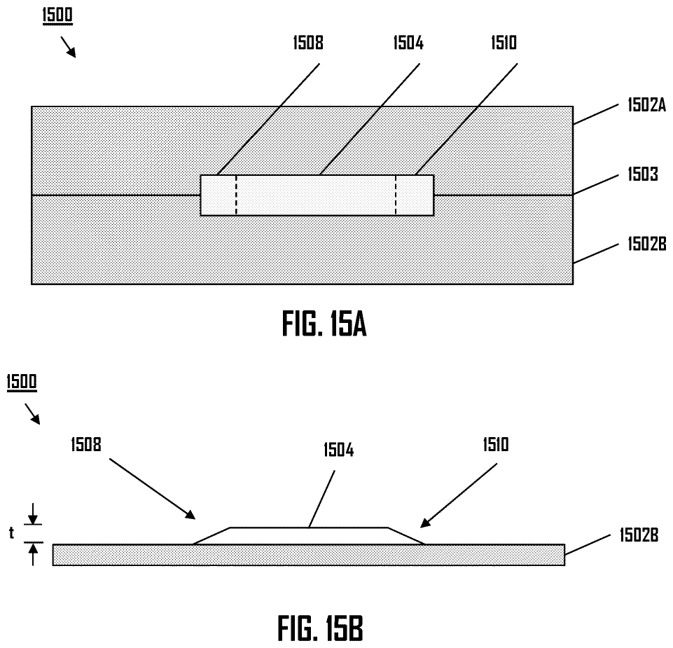

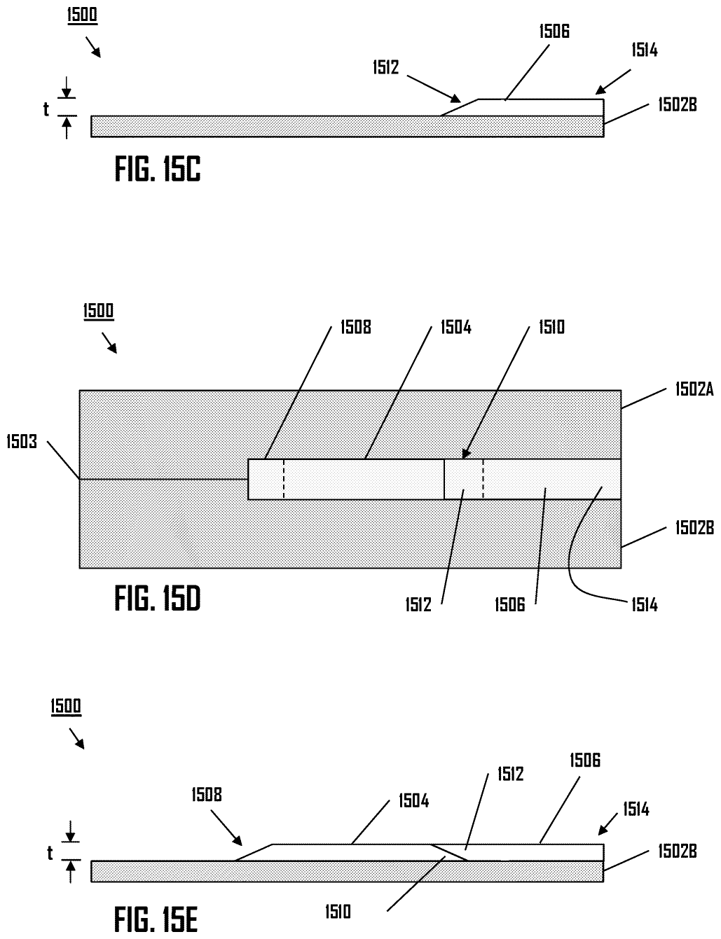

FIGS. 15A, 15B, 15C, 15D, and 15E are diagrams of an assembly 1500 in which a surface finishing system sprays material on an assembly 1500 to achieve system specific coating parameters by varying parameters of an end effector. Assembly 1500 includes seam 1503 formed by adjacent edges of substrate pieces 1502A and 1502B. FIG. 15A shows a front view of assembly 1500; FIGS. 15B, 15C, and 15D show a side view of the assembly 1500. Turning to FIGS. 15A and 15B, a material sprayed on seam 1503 forms the coating 1504. The coating 1504 has a thickness of t. The coating 1504 includes tapered ends 1508 and 1510, each of which tapers down from the thickness of t until they terminate. In this example, the speed of an end effector applying the coating 1504 is varied to control the thickness of the material and, thereby, create the tapered ends 1508 and 1510. As disclosed herein, the thickness of the material is inversely proportional to the speed of the end effector when applying the material. Thus, when the seam is sprayed from left to right relative to the FIGS. 15A and 15B, the end effector spraying the material would begin spraying tapered end 1508 while decelerating (e.g., to taper up from zero to t), maintain a constant speed to spray the middle section of the coating 1504 (e.g., to maintain a constant thickness of t), and accelerate while spraying tapered end 1510 (e.g., to taper down from t to approach zero). Advantageously, these tapered ends 1508 and 1510 enable coatings to be sprayed in discrete sections. When the tapered ends 1508 and 1510 overlap tapered ends of adjacent coatings, they create a relatively uniform thickness even in cases where there is some misalignment between the discrete sections of coatings.

Turning to FIG. 15C which illustrates the material forming the coating 1506 sprayed on the seam 1503. The coating 1506 has a thickness of t. The coating 1506 includes a tapered end 1512 and flat end 1514. When the seam is sprayed from left to right relative to the FIG. 15C, the end effector spraying the material would begin spraying tapered end 1512 while decelerating (e.g., to taper up the thickness to reach t), maintain a constant speed to spray the middle section of the coating 1506 (e.g., maintain a constant thickness of t), and rotate while spraying flat end 1514 (e.g., to taper down the thickness from t to approach zero). The flat end 1514 is sprayed by rotating the end effector from perpendicular to the sprayed surface to an oblique angle to the sprayed surface (also referred to herein as a “flick”). A flick is a motion or combination of motions executed by the system to direct the material at an oblique angle relative to the sprayed surface. A flick can be executed by varying (individually or in combination) any degree of freedom of the positioning system, lift system, robotic arm, and/or the end effector. Advantageously, such rotation or flicking of the end effector can prevent collisions between the end effector and obstacles while enabling a spray of material from the end effector to reach portions of the sprayed surface near the obstacles. For clarity of the Figures, FIG. 15C illustrates the coating 1506 separate from the coating 1504. FIGS. 15D and 15E illustrate the coating 1506 sprayed overlapping the coating 1504. Advantageously, the tapered ends 1510 and 1512 overlap to create a uniform thickness of t, though the coatings 1504 and 1506 were sprayed in discrete sections.

The description provided with respect to the direction of spray (e.g., sprayed from left to right relative to the Figures) is provided only for simplicity and clarity of the description. Surface finishing systems of the present disclosure can spray in any direction, e.g., left to right, right to left, top to bottom, bottom to top, or at any other orientation and direction. Such direction of spray can also be determined by a planner using a kinematic model of the system. For example, the system may determine a plurality of possible toolpaths for the end effector including the direction of spray. The planner may select, from the plurality of possible toolpaths, the most efficient way to spray a coating. The most efficient can include e.g., shortest distance, shortest time to complete, least energy used, or any other objective function.

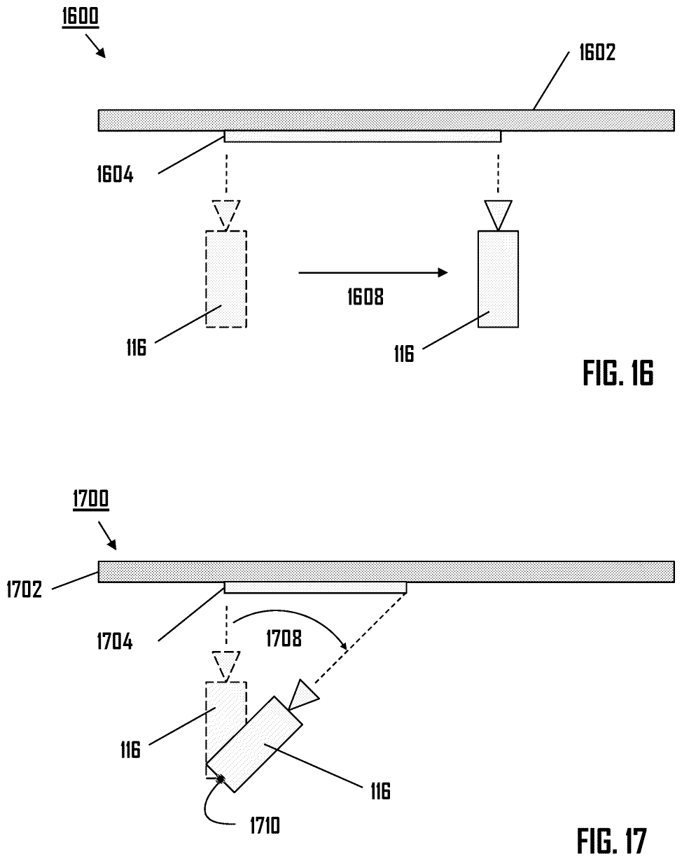

FIG. 16 illustrates a system 1600 in which end effector 116 (e.g., of a surface finishing system) sprays a material 1604 onto a substrate 1602. The Figure shows system 1600 from a top (plan) view. While the end effector 116 applies the material 1604, the end effector 116 moves from a first position (shown in dashed lines) to a second position while moving in the direction 1608. Throughout the movements, the end effector 1166 remains perpendicular to the substrate 1602. Such movement may require complex movements from any components driving the movement of the end effector 116. In some cases, a kinematic model is used to calculate the required complex movements from such components. The kinematic model may model the movement of a positioning system, a lift system, a robotic arm, the end effector, or any combination thereof. In some examples, movements of the end effector described with respect in FIG. 16 are used in systems disclosed herein to spray both constant thickness portions and tapered ends of coatings by varying the speed of the end effector.

FIG. 17 illustrates a system 1700 in which an end effector 116 (e.g., of a surface finishing system) sprays a material 1704 onto a substrate 1702. The Figure shows system 1700 from a top (plan) view. The end effector 116 executes a flick motion while applying the material 1704. The end effector 116 executes a flick motion by rotating in the direction 1708 about an axis passing through point 1710 (the axis lies in the Z direction). In doing so, the end effector 116 moves from being perpendicular to the substrate 1702 to then being at an oblique angle relative to the substrate 1702. Advantageously, the flick motion of the end effector 116 can prevent collisions between the end effector 116 and obstacles (e.g., floor, wall, ceiling, protrusions, and the like) while enabling material sprayed from the end effector 116 to reach portions of the substrate 1702 near the obstacles. In some examples, the flick is further varied by moving the end effector 116 closer to or farther from the wall while executing the flick motion, e.g., to modify and/or maintain the width of the material 1704. In some examples, movements of the end effector described with respect in FIG. 17 are used in systems disclosed herein to spray both constant thickness portions and flat ends of coatings by varying the speed of the end effector.

The rotation described with respect to FIG. 17 is independent from rotations described with respect to FIGS. 13 and 14 (e.g., fan bias angle). Each of these rotations can be varied independently from one another. In some examples, these axes are perpendicular to one another. It is noted that the flick motion described with respect to FIG. 17 is a non-limiting example of a flick motion. A flick may be executed using any degree of freedom of a positioning system, lift system, robotic arm, and/or end effector.

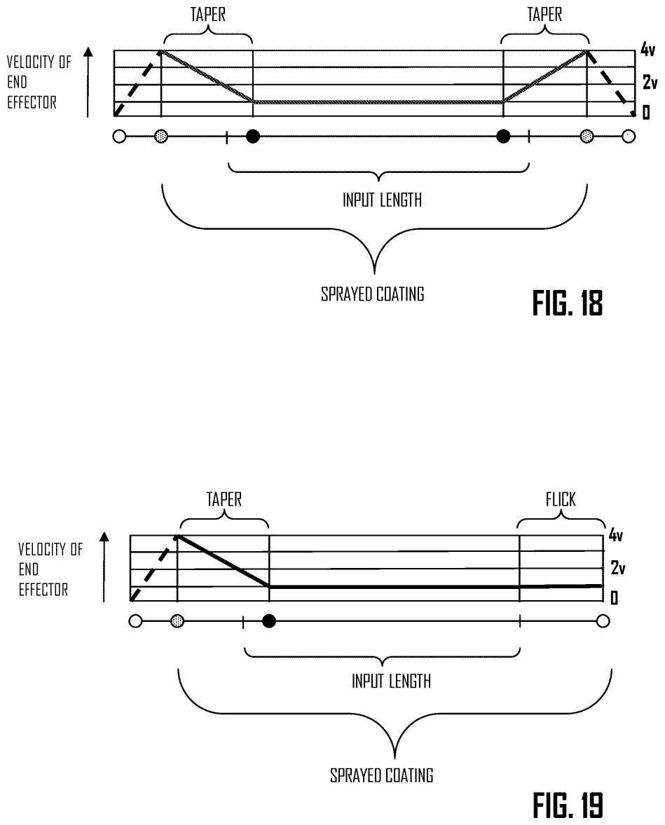

FIGS. 18, 19, 20, and 21 illustrate various movements of an end effector (e.g., of a surface finishing system) to spray and terminate spraying a coating on an input length on a surface. Each of the Figures includes a graph of the velocity of the end effector on a vertical axis and the position along the length of the coating on the horizontal axis. The vertical axis ranges from zero to 4*v, where vis a base or nominal velocity (e.g., in meters/second) for the end effector. The plot line shown on the graph is solid when the end effector is applying the material to coat the surface and is dashed when the end effector is not applying the material to the surface. The thickness of the coating is inversely proportional to the velocity of the end effector when applying the coating. Increasing the speed of the end effector reduces the thickness of the coating. Decreasing the speed of the end effector increases the thickness of the coating. In each case, the sprayed coating is longer than the nominal length of the input length. Advantageously, this overlay enables ends of adjacent sprayed coating sections to overlap and form a uniform thickness.

FIG. 18 is a graph showing the behavior of an end effector when spraying a portion of a seam that is tapered on both ends. The end effector begins by accelerating up to a maximum velocity, 4*v. Upon reaching the maximum velocity, the end effector initiates spraying the coating on the seam while linearly decelerating to linearly taper up the thickness of the coating from zero to a thickness of t. Upon reaching the base velocity, the end effector continues spraying while moving at a constant velocity to maintain the thickness of t. Upon reaching the next tapered end, the end effector linearly accelerates from the base velocity up to a maximum velocity accelerate while continuing to spray to linearly taper down the thickness of the coating from t to zero. Upon reaching the maximum velocity and the end of the sprayed coating, the end effector terminates spraying the coating at the second end and decelerates to a stop.

FIG. 19 is a graph showing the behavior of an end effector when spraying a portion of a seam that is tapered on a first end and flicked on a second end. The end effector begins by accelerating up to a maximum velocity, 4v. Upon reaching the maximum velocity, the end effector initiates spraying the first end of the coating on the seam while linearly decelerating to linearly taper up the thickness of the coating from zero to a thickness of t. Upon reaching the base velocity, the end effector continues spraying while moving at a constant velocity to maintain the thickness of t. Upon reaching the flicked second end, the end effector executes a flick motion while maintaining a constant velocity. Upon reaching the end of the sprayed coating, the end effector terminates spraying the coating at the second end and stops the flick motion.

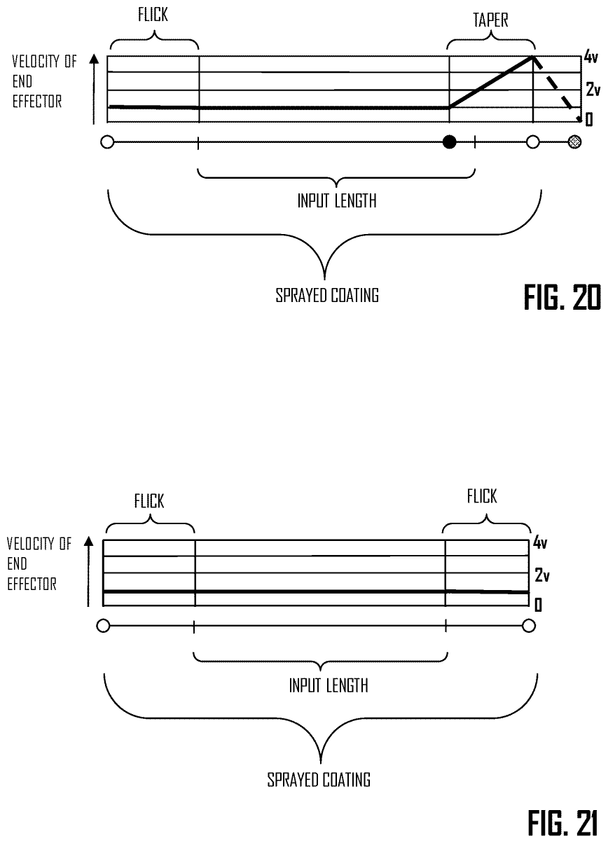

FIG. 20 is a graph showing the behavior of an end effector when spraying a portion of a seam that is flicked on a first end and tapered on a second end. The end effector begins by executing a flick motion at the base velocity to spray the first flicked end. The end effector continues moving at the base velocity while spraying to maintain the thickness of t. Upon reaching the tapered end, the end effector linearly accelerates from the base velocity up to a maximum velocity while continuing to spray to linearly taper down the thickness of the coating from t to zero. Upon reaching the maximum velocity and the end of the sprayed coating, the end effector terminates spraying the coating and decelerates to a stop.

FIG. 21 is a graph showing the behavior of an end effector when spraying a portion of a seam that is flicked on both ends. The end effector begins by executing a flick motion at the base velocity to spray the first flicked end. The end effector continues moving at the base velocity while spraying to maintain the thickness of t. Upon reaching the flicked second end, the end effector executes a flick motion while maintaining a constant velocity. Upon reaching the end of the sprayed coating, the end effector terminates spraying the coating at the second end and stops the flick motion.

In some examples, flicks and constant velocity sections described with respect to FIGS. 18, 19, 20, and 21 are executed as described with respect to FIG. 16 and tapers described with respect to FIGS. 18, 19, 20, and 21 are executed as described with respect to FIG. 17.

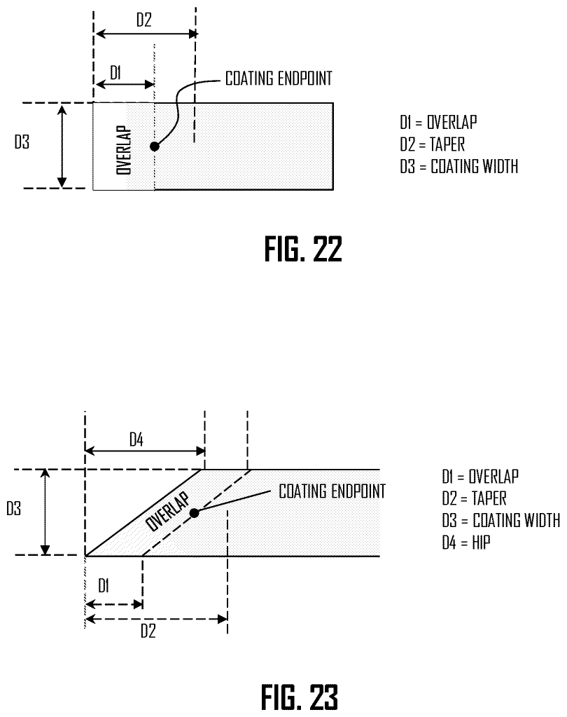

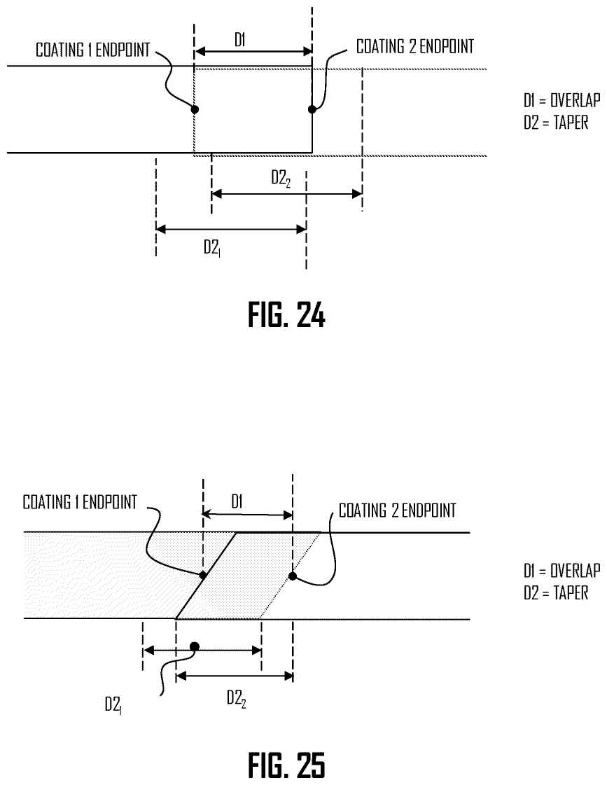

FIGS. 22 and 23 are front views of portions of a coating sprayed with an end effector (e.g., of a surface finishing system) at various fan bias angles. FIG. 24 is a front view of adjacent coatings applied in a manner as illustrated in FIG. 22. FIG. 25 is a front view of adjacent coatings applied in a manner as illustrated in FIG. 23.

FIG. 22 illustrates a single coating sprayed with a zero-degree fan bias angle. The coating width D3 is the full width of a fan produced by the end effector. The coating has a tapered end of dimension D2. The coating can overlap adjacent coatings by dimension D1 as illustrated in FIG. 24. FIG. 24 illustrates two adjacent coatings (i.e., coating one and coating two) sprayed with a zero-degree fan angle. The coatings overlap one another by dimension D1. In this case, the overlap dimension D1 is less than the full length of the taper dimension D2.

FIG. 23 illustrates a single coating sprayed with a fan bias angle between zero and 360 degrees (fan bias angle is non-zero). The coating width D3 is less than the full width of a fan produced by the end effector. Due to the bias angle, the end effector creates a hip region of dimension d4 that is partially coated. The coating has a tapered end of dimension D2. The coating can overlap adjacent coatings by dimension D1 as illustrated in FIG. 25. FIG. 25 illustrates two adjacent coatings (i.e., coating one and coating two) sprayed with a fan bias angle between zero and 360 degrees. The coatings may overlap with one another by dimension D1. In this case, the overlap dimension D1 is less than the full length of the taper dimension D2.

In some cases, a fan bias angle can be adjusted (e.g., changed by 90 degrees, flipped 180 degrees, etc.), by a planner, to achieve a target surface profile of the material. The fan bias angle may be X degrees for a first coating, and the fan bias angle may be X+180 degrees for a second coating.

In some cases, the fan bias angle can be adjusted as the end effector moves at a certain velocity. The adjustment in fan bias angle may change the coating width and surface profile of the coating.

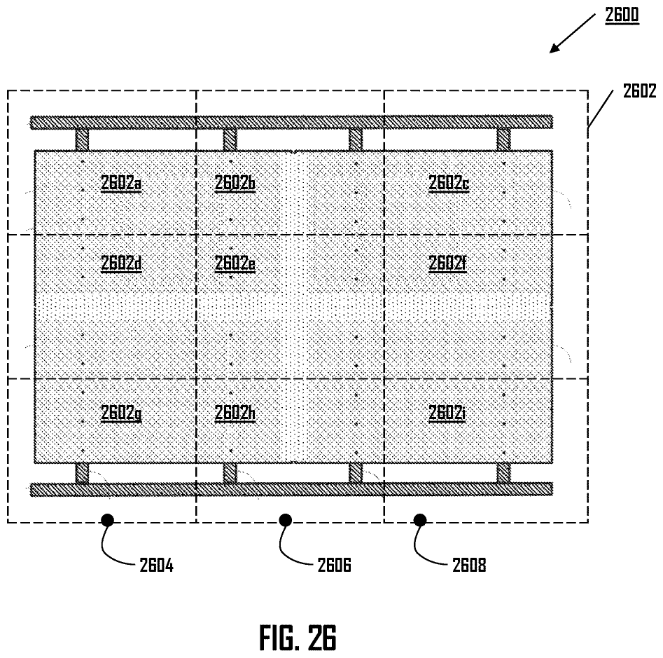

In some cases, spraying multiple coatings with overlapping or superposed areas may achieve a target surface profile of the material. In some cases, spraying multiple coatings with overlapping areas, where the coatings may be performed with different parameters such as fan bias angle, spray pattern centerline, spray pattern length, speed, and with or without a flicking motion, to achieve a target profile of the material. In one example, multiple coatings may be applied in a line from point A to point B, where the first coating may be applied using a fan bias angle of Y, and the second coating may be applied using a fan bias angle of Y+180 degrees. In another example, a first coating may be applied using a fan bias angle of Y on a first line from point A1 to B1, and a second coating may be applied using a fan bias angle of Y+180 on a second line parallel and adjacent to the first line from point A2 to B2. FIG. 26 illustrates data 2600 generated by a planner (e.g., of a surface finishing system). The data 2600 includes a digital representation of a wall assembly. The wall assembly includes seams between components of the assembly. The planner generates a plan for selectively applying a coating to the wall assembly. The planner generates the plan by partitioning the assembly into a plurality of partitions 2602, comprising partitions 2602a, 2602b, 2602c, 2602d, 2602e, 2602f, 2602g, 2602h, and 2602i. The planner determines the size of each of the partitions. For example, the planner may determine the size based on a maximum reach of a surface finishing system applying the coating and/or by obstacles on or around wall assembly. A kinematic model of the surface finishing system models movement of one or more of the components of the surface finishing system. Such components can include a positioning system, a support, a lift system, a robotic arm, and/or an end effector. In such examples, the planner can determine a threshold dimension of the maximum work area of the surface finishing system and/or whether the system is able to dynamically reach portions of the assembly based at least in part on the kinematic model. Target dimensions of a partition are set based on, e.g., a maximum reach of the system, nearby obstructions, the kinematic model, movement constraints of the system, other factors, or any combination thereof. The planner then sets a target dimension of each of the plurality of partitions 2602 to be less than or equal to the threshold dimension of the maximum work area of the system.

The planner determines a target location of the surface finishing system to reach the seams within a partition. To determine the target location, the planner may use the kinematic model to solve for a target location of a base unit at which an end effector is able to reach seams within one of the partitions 2602. The planner determines that the system can reach seams in the partitions 2602a, 2602d, and 2602g while located at point 2604 (or location 2604). Point 2604 is centered on the partition 2602 to enable symmetric access to each side of the partition 2602d. The planner can determine such a location specific to the task being performed. Because partitions 2602a and 2602g do not include seams to be coated, the planner may discard limitations associated with the reachability of these partitions and only consider partition 2602d when determining the location 2604. The planner determines that the surface finishing system can reach seams in the partitions 2602b, 2602e, and 2602h while located at point 2606 (or location 2606). Point 2606 is centered on the partitions 2602b, 2602e, and 2602h to enable symmetric access to each side of these partitions. Because partitions 2602b, 2602e, and 2602h have seams to be coated, the planner considers the reachability of them all when determining the location 2606. The planner determines that the surface finishing system can reach and spray the seams in the partitions 2602c, 2602f, and 2602i while located at point 2608 (or location 2608). Point 2608 is offset to the left of the center of the partitions 2602c, 2602f, and 2602i to enable the surface finishing system to avoid obstacles on the right side of these partitions. Because partitions 2602c and 2602i do not include seams to be coated, the planner may discard limitations associated with the reachability of these partitions and only consider partition 2602i when determining the location 2608.

A positioning system may be used to drive the surface finishing system to the target location associated with one or more of the partitions 2602. For example, a drive system can transmit control input to the positioning system. The positioning system drives the surface finishing system within a threshold distance of the target location based on the control input. Such control input may be generated based on manual input or computer-generated output or both. For example, the drive system company one or more of a user input device (e.g., lever, joystick, one or more keys, motion capture system, a computational device), a fully autonomous drive algorithm, and/or a semi-autonomous drive algorithm for directly or indirectly generating control inputs. In further examples, the user input device receives an input confirming that the base unit is within a threshold distance of the target location.

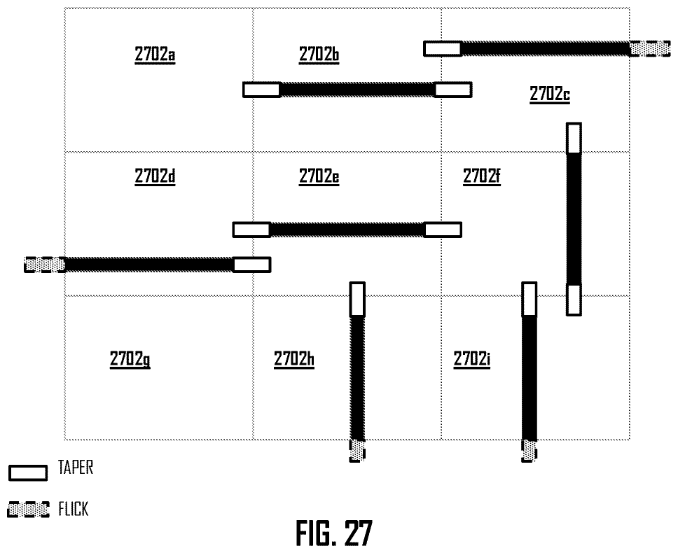

Each of the seams span across multiple partitions. Thus, the surface finishing system can spray a coating on a portion of the seam while located at a first point and then move to a second point to spray adjacent portions of the seam. If the joints were not tapered and abruptly stopped, any misalignment between coatings in adjacent partitions could create gaps in the coatings or result in a thickness that is double that of the desired thickness. The ends of the coatings being tapered enables the coatings sprayed in adjacent partitions to blend with one another even when there is misalignment between the coatings sprayed in adjacent partitions. FIG. 27 illustrates some aspects of tapering or flicking the ends of joints.

The example of FIG. 26 illustrates the partitions being smaller than the object being sprayed with material. In other examples the object may be sprayed in a single partition. For example, the positioning system may be used to drive the surface finishing system across multiple partitions and provide a continuous spray across one or more of the partitions shown in FIG. 26. Thus, in some examples, the surface finishing system may spray an entire horizontal and/or vertical seam across a full width of the wall assembly in a single, continuous pass (without stopping at the line between partitions).

In some examples, a planner can use multiple processes to create partitions and then apply coatings within them. For example, the planner may execute a global planning process and a local planning process. In the global planning process, the partitions are created using only rough dimensions of the wall assembly (e.g., before the surface finishing system uses a perception system to “see” the object and, thus, has limited knowledge of the seams). When the surface finishing system is positioned at a location near a partition, it is repositioned (using the positioning system and/or lift system) with respect to these partitions so that it can see the seams on the wall assembly. The planner executes the local planning process to create a plan for spraying the coating on the seams (e.g., what order of seams, what arm configurations (e.g., parameters of the surface finishing system), toolpath, and the like). When it determines that some seams are kinematically infeasible (e.g., this may be possible when the partitions are created with limited knowledge of the seams), the planner uses the kinematic model to compute a new position(s) from which the system can reach and spray the seam.

FIG. 27 illustrates data 2700 generated by a planner. The data 2700 includes a digital representation of a component. The planner generates a plan for selectively applying a coating to seams of the component. The planner generates the plan by partitioning the assembly into a plurality of partitions 2702, comprising partitions 2702a, 2702b, 2702c, 2702d, 2702e, 2702f, 2702g, 2702h, and 2702i. The planner creates, within partitions 2702, regions in which seams would be coated by a system of the present disclosure. For each region the planner determines whether the ends of the seam should be tapered or flicked. The planner tapers the ends where it plans to apply a coating in an adjacent partition. The planner flicks the ends near the edge of the component, to reduce the likelihood of colliding with obstructions around the component.

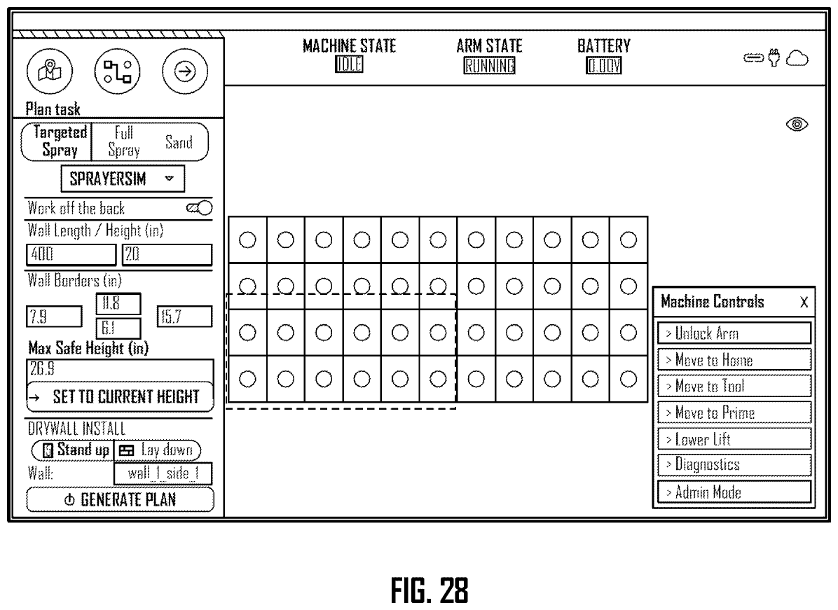

FIGS. 28, 29, 30, 31, 32, 33, and 34 illustrate user interfaces displayed on a user input device for selectively applying a coating to a wall assembly. The user interfaces are operable to receive user input and to generate and/or display graphic representations of data of the present disclosure. The user inputs are used to operate a surface finishing system of the present disclosure.

FIG. 28 illustrates a user interface for planning a task. The user interface receives inputs related to selectively applying coating to a wall assembly. The user interface has input data related to wall length, wall height, and wall finish height, wall borders, a maximum safe height of the surface finishing system, and the orientation of the drywall boards. In this case, the selected orientation is vertical (stand up) instead of horizontal (lay down). An input is received to generate the plan for applying the coating to the wall assembly based on a selection of the button labeled “GENERATE PLAN”. The plan is generated based on the input.

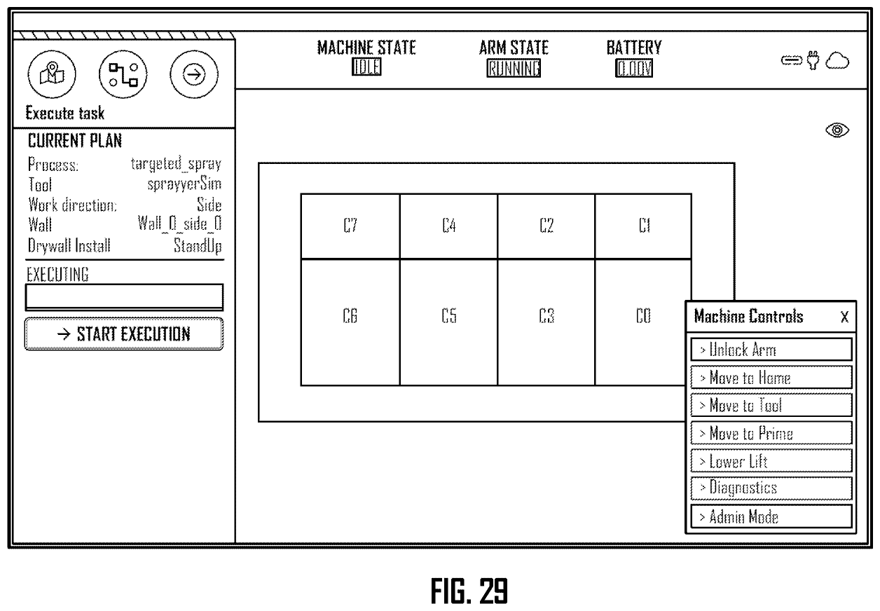

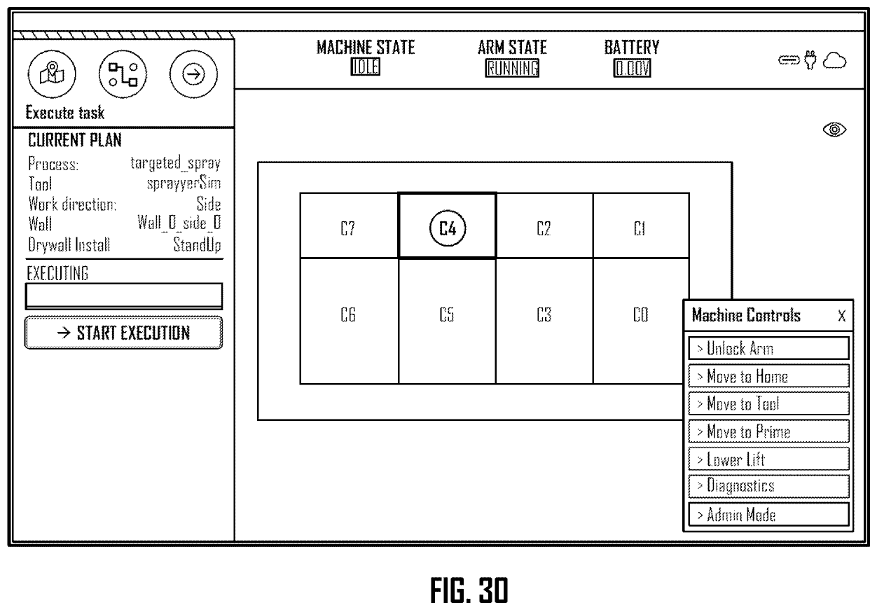

FIGS. 29 and 30 illustrate a user interface for viewing a plan and executing a task based on the plan. The user interface shows parameters of the plan including, among other things, the process of target spray, the type of wall being used to spray the coating, and the orientation of the drywall boards in the wall assembly. The process name “targeted_spray” indicates that the system is being configured to selectively spray seams as opposed to covering the entire wall. The generated plan includes a 2×4 array of partitions, labeled C0, C1, . . . , C7. FIG. 30 illustrates a user selection of the partition C4. An input is received to execute the plan to apply the coating to the wall assembly based on a selection of the button labeled “START EXECUTION”. Execution of the plan (e.g., to initiate spraying at the desired partition) is initiated based on the input.

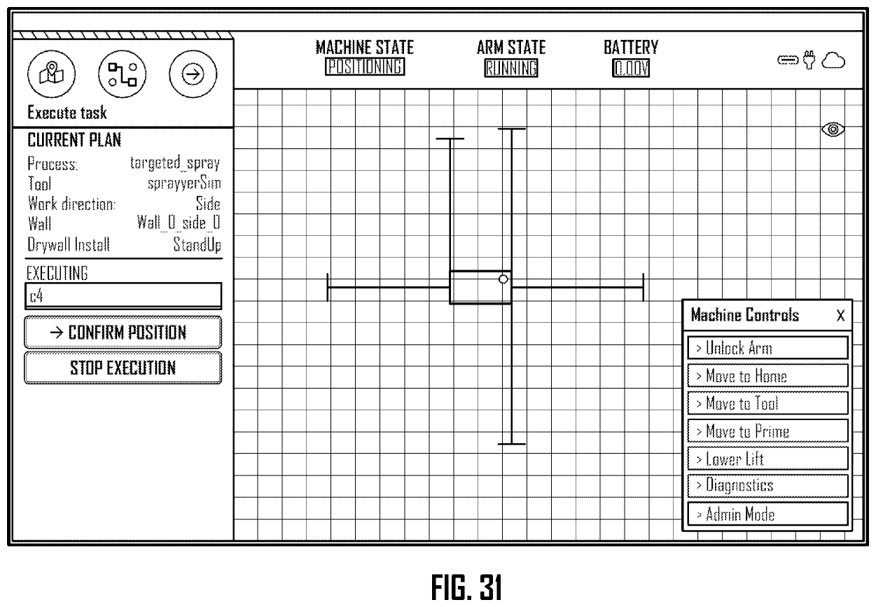

FIG. 31 illustrates a user interface associated with a positioning process for execution of the plan. The user interface shows parameters of the positioning process including, among other things, a location of a base unit relative to objects around the base unit, a first button labeled “CONFIRM POSITION” to confirm the position, and a second button labeled “STOP EXECUTION” to stop execution of the plan. Such position data can be detected by perception systems. In some examples the bars extending from the base unit show a current location of the base unit and a target location of the base unit while the base unit is driven to arrive at the target location. Selection of the first button confirms that the base unit is within a threshold distance of the target location. The plan continues by executing a subsequent process based on selection of the first button. The plan stops executing based on the selection of the second button.

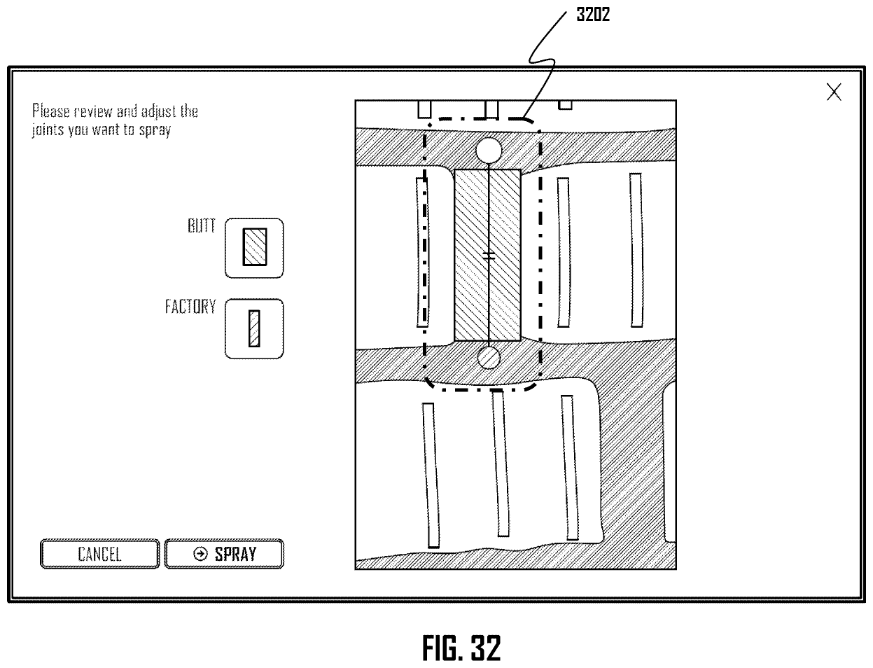

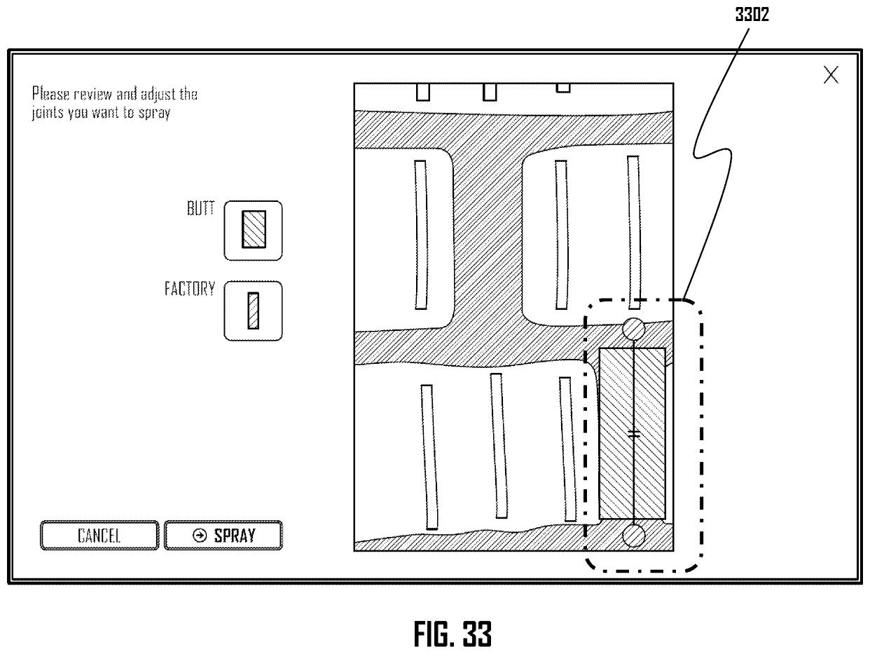

FIGS. 32 and 33 illustrate user interfaces associated with a seam detection algorithm, e.g., implemented in a perception system. The user interface shows an output from the algorithm. User interfaces seen in FIGS. 23 and 33 illustrate the output as user interface elements 3202 and 3302 respectively overlaid on a camera image captured by the surface finishing system. User interface elements 3202 and 3302 each include a bounding box around a seam, a centerline representing the seam, and elements (e.g., circles) that represent endpoints of the centerline. The user interface shows options for the type of seam including butt seam and factory seam (i.e., a tapered seam). The user interfaces allow a user to provide user input to select the type of the seam. For example, a selection of the button labeled “FACTORY” can set the type of the seam to a tapered seam. A selection of the button labeled “BUTT” can set the type of the seam to a butt seam. The seam type selection provided by the user may be collected as training data or feedback data for a machine learning model being trained to identify the type of seam. In some cases, the user interfaces may allow a user to move the visual elements representing seams on the user interface (e.g., using arrow buttons, and/or a drag and drop user interaction with elements in the user interface elements 3202 and 3302) to correct the length, location, and/or orientation of the seam to match the actual length, location, and/or orientation of the seam. The user input correcting the length, location, and/or orientation may be collected as training data or feedback data for a machine learning model being trained to locate the seam (or edges of components). The user input correcting length, location, and/or orientation may be used to calibrate fixed offsets of the machine learning model. The user interface may receive a selection of the button labeled “SPRAY” to confirm the current selection of butt seam. Any spraying executed based on selection of the spray button, can follow the instructions present at that time (e.g., based on whether butt or factory is selected).

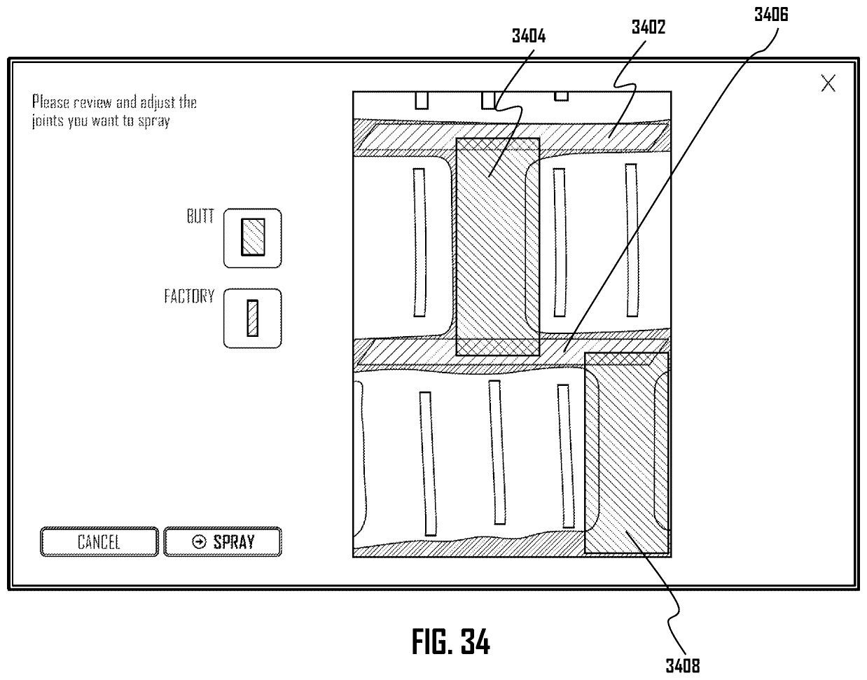

FIG. 34 illustrates a user interface associated with a seam detection algorithm, e.g., implemented in a perception system. The user interface shows an output from the algorithm. The output includes bounding boxes 3402, 3404, 3406, and 3408 representing regions on the camera image of the seam overlaid on camera image captured by the surface finishing system. The algorithm may have detected four different seams, which may be represented by bounding boxes 3402, 3404, 3406, and 3408. The bounding boxes may be shaded to indicate the type of seam. The horizontal seams are tapered seams. The vertical seams are butt seams. Shading of the bounding boxes may be different depending the type of seam detected. The bounding boxes 3402, 3404, 3406, and 3408 can represent regions where material may be sprayed to cover the specific seam. In some cases, the user interfaces may allow a user to adjust the bounding boxes representing regions where material is to be sprayed on the user interface (e.g., using arrow buttons, and/or a drag and drop user interaction with bounding boxes 3402, 3404, 3406, and 3408) to change the width, length, location of the bounding boxes to represent a desired region where material is to be sprayed. The user input changing the bounding box may be collected as training data or feedback data for a machine learning model being trained to generate regions where material is to be sprayed to cover the seams. The user input changing the bounding box may be used to calibrate fixed offsets of the machine learning model. The user input changing the bounding box may be used to reinforce learning of desired spraying regions by the machine learning model.

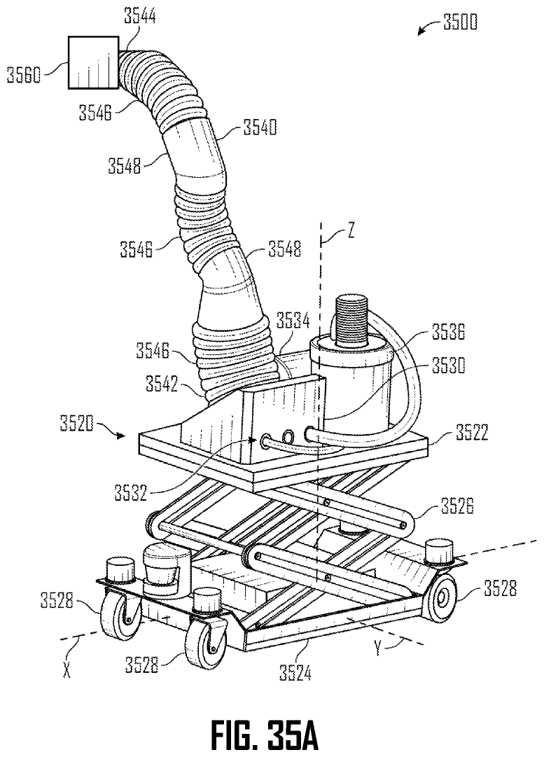

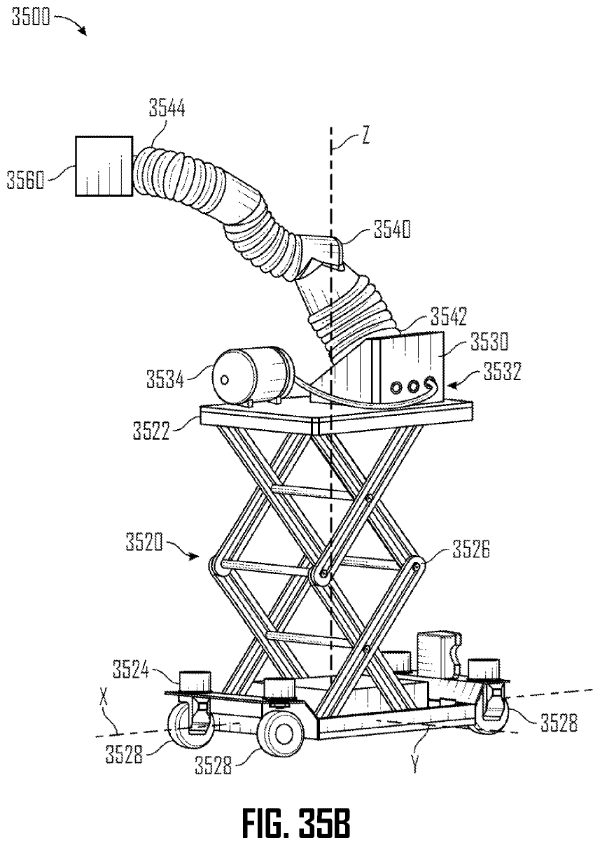

Turning to FIGS. 35A and 35B, additional exemplary versions of a surface finishing system 100 are illustrated, which includes a base unit 3501, a robotic arm 3540 (as one example of a positioning system) and an end effector 3560. The base unit 3501 comprises a platform 3522 and a cart 3524 with a lift 3506 disposed between the platform 3522 and cart 3524. The cart 3524 can be configured to be disposed on the ground and move within an XY plane defined by axes X and Y, and the lift 3506 can be configured to raise the platform 3522 up and down along axis Z, which is perpendicular to axes X and Y.

In the examples of FIGS. 35A and 35B, a different embodiment of the surface finishing system 100 is shown. The cart 3524 can comprise a plurality of wheels 3528, which can be used to move the cart 3524 and surface finishing system 100 on the ground in the XY plane. Such movement can be motorized or can be non-motorized. For example, in some embodiments, the surface finishing system 100 can be configured for automated movement of the cart 3524, motorized movement based on input from a user and/or non-motorized movement based on physical movement by a user. Additionally, while an example having wheels 3528 is shown in some examples herein, it should be clear that the cart 3524 can be configured for motorized and/or non-motorized movement via any suitable structures, systems, or the like.

In the examples of FIGS. 35A and 35B, the lift 3506 is shown comprising a scissor lift that can raise and lower the platform 3522 relative to the cart 3524 along axis Z. Such movement can be motorized or can be non-motorized. For example, in some embodiments, the surface finishing system 100 can be configured for automated movement of the lift 3506, motorized movement of the lift 3506 based on input from a user and/or non-motorized movement based on physical operation of the lift 3506 by a user. Additionally, while an example of a scissor lift is shown herein, it should be clear that any suitable lift system can comprise the lift 3506 without limitation.

Platform 3522 can comprise a hub 3530, which can couple with the robotic arm 3540 at a base end 3542 of the robotic arm 3540. The hub 3530 can comprise an input interface 3532 that allows for various systems to couple with the hub 3530, which can allow for resources provided by such systems to be provided to the robotic arm 3540 and/or the end effector 3560 coupled at a distal end 3544 of the robotic arm 3540 as discussed in more detail herein. For example, a pneumatic source, a power source, a vacuum source, a paint source, a coating or joint compound source, or the like can be coupled to the hub 3530.

FIG. 35A illustrates an example having an air compressor 3534 and a vacuum source 3536 coupled to the hub 3530. FIG. 35B illustrates an example having an air compressor 3534 coupled to the hub 3530, which can be used to power pneumatic actuator units 3546 of the robotic arm 3540 and/or provide compressed air to the end effector 3516 at the distal end 3544 of the robotic arm 3540.

In various embodiments, the robotic arm 3540 can comprise any suitable robotic arm or positioning stage system, which can include pneumatic actuators, electric actuators, and the like. The robotic arm 3540 can have any suitable number of degrees of freedom. Although the examples of FIGS. 35A and 35B illustrate an example having pneumatic actuator units 3546 separated by arm couplers 3548, this example configuration should not be construed to be limiting on the wide variety of robotic arms 3540 or positioning stages that are within the scope and spirit of the present disclosure.

As discussed herein, an end effector 3560 can be coupled at the distal end 3544 of the robotic arm 3540. The end effector 3560 and the rest of the surface finishing system 100 can be controlled to perform various tasks described herein. In some examples, the surface finishing system 100 can comprise modular and/or multi-use end effectors 3560, which can be configured for various drywalling, construction, or other tasks. For example, as discussed herein, end effectors 3560 can be configured for substrate planning, substrate hanging, applying coating or joint compound to hung substrate, sanding the coating, painting, and the like. Although various examples herein relate to drywalling and construction, further embodiments of the surface finishing system 100 can be configured for any suitable tasks, including construction tasks, manufacturing tasks, gardening tasks, farming tasks, domestic tasks, and the like. Accordingly, the discussions herein related to drywalling and construction should not be construed to be limiting on the wide variety of tasks that the surface finishing system 100 can be configured for.

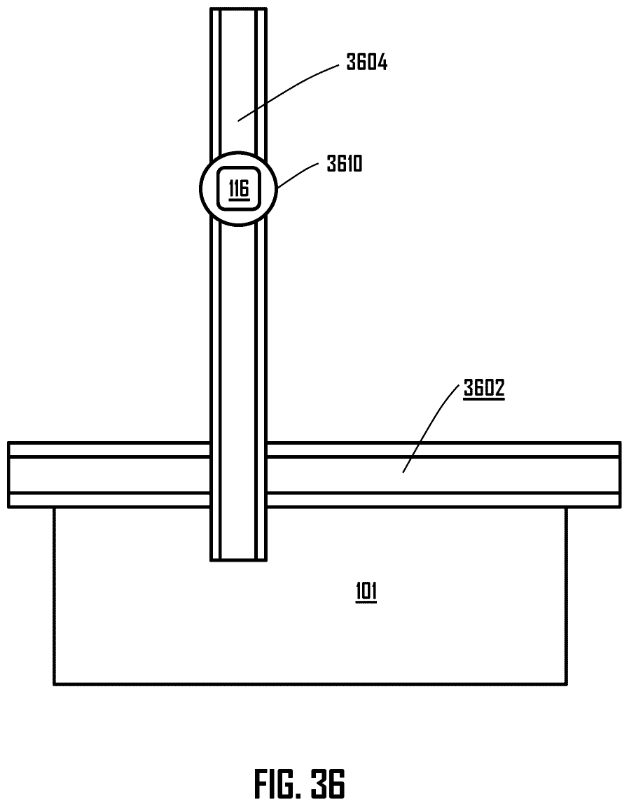

Turning to FIG. 36, an exemplary version of a surface finishing system 100 is illustrated, which can include a base unit 101, an end effector 116, a gantry XY positioning system (as one example of a positioning system) having track 3602 for moving in a first direction and track 3604 for moving in a second direction perpendicular to the first direction. The end effector 116 may be attached to the gantry positioning system, and the position of the end effector 116 may be adjusted using the gantry positioning system. The speed of the end effector 116 may be controllable by controlling the gantry positioning system. In addition to the gantry positioning system, the surface finishing system 100 may include a mechanical component 3610 that can rotate the orientation of end effector 116 (e.g., to adjust a fan bias angle of a spraying end effector). The mechanical component 360 can perform a flicking movement in some cases.

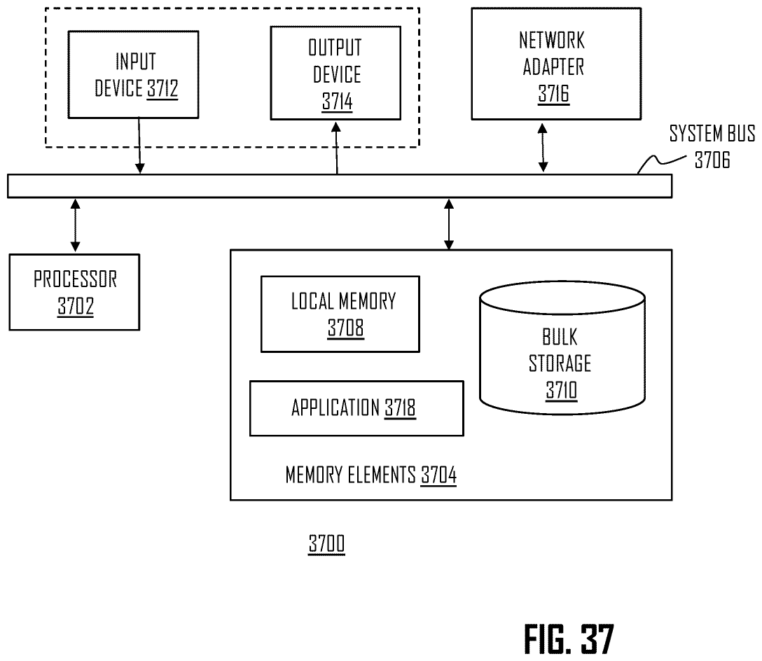

FIG. 37 depicts a block diagram illustrating an exemplary computing system 3700 that may be used to implement systems such as the control systems, perception systems, planners, decision trees, logic, machine learning models, algorithms, software processes, and/or interfaces described herein, according to some embodiments of the disclosure. Surface finishing systems as described herein may include a system implemented as computing system 3700. User input systems as described herein may be implemented as computing system 3700. For instance, the illustrated surface finishing systems may have one or more of the components of the computing system 3700 or their functionalities may be implemented with one or more components of computing system 3700. As shown in FIG. 37, the computing system 3700 may include at least one processor 3702 coupled to memory elements 3704 through a system bus 3706. As such, the computing system 3700 may store program code within memory elements 3704. Further, the at least one processor 3702 may execute the program code accessed from the memory elements 3704 via a system bus 3706. The program code may encode functions described within this Specification.

The memory elements 3704 may include one or more physical memory devices such as, for example, local memory 3708 and one or more bulk storage devices 3710. The local memory may refer to random access memory or other non-persistent memory device(s) generally used during actual execution of the program code. A bulk storage device may be implemented as a hard drive or other persistent data storage device. The computing system 3700 may also include one or more cache memories (not shown) that provide temporary storage of at least some program code in order to reduce the number of times program code must be retrieved from the bulk storage device 3710 during execution.

Input/output (I/O) devices depicted as an input device 3712 and an output device 3714 optionally can be coupled to the computing system 3700. Examples of input devices may include, but are not limited to, a keyboard, a touch-sensitive screen, buttons, a pointing device such as a mouse, or the like. Examples of output devices may include, but are not limited to, a monitor or a display, a touch-sensitive screen, speakers, or the like. Input and/or output devices may be coupled to the computing system 3700 either directly or through intervening I/O controllers.

In an embodiment, the input and the output devices may be implemented as a combined input/output device (illustrated in FIG. 37 with a dashed line surrounding the input device 3712 and the output device 3714). An example of such a combined device is a touch-sensitive screen, also sometimes referred to as a “touch screen display” or simply “touch screen”. In such an embodiment, input to the device may be provided by a movement of a physical object, such as, e.g., a stylus or a finger of a user, on or near the touch screen display.

A network adapter 3716 may also be coupled to the computing system 3700 to enable it to become coupled to other systems, computer systems, remote network devices, and/or remote storage devices through intervening private or public networks. The network adapter may comprise a data receiver for receiving data that is transmitted by said systems, devices and/or networks to the computing system 3700, and a data transmitter for transmitting data from the computing system 3700 to said systems, devices and/or networks. Modems, cable modems, cellular network cards, and Ethernet cards are examples of different types of network adapter that may be used with the computing system 3700.

As pictured in FIG. 37, the memory elements 3704 may store an application 3718. In various embodiments, the application 3718 may be stored in the local memory 3708, the one or more bulk storage devices 3710, or apart from the local memory and the bulk storage devices. It should be appreciated that the computing system 3700 may further execute an operating system (not shown in FIG. 37) that can facilitate execution of the application 3718. The application 3718, being implemented in the form of executable program code, can be executed by the computing system 3700, e.g., by the at least one processor 3702. Responsive to executing the application, the computing system 3700 may be configured to perform one or more functionalities, operations, or method steps described herein.

Persons skilled in the art will recognize that while the elements 3702-3718 are shown in FIG. 37 as separate elements, in other embodiments their functionality could be implemented in fewer number of individual elements or distributed over a larger number of components.

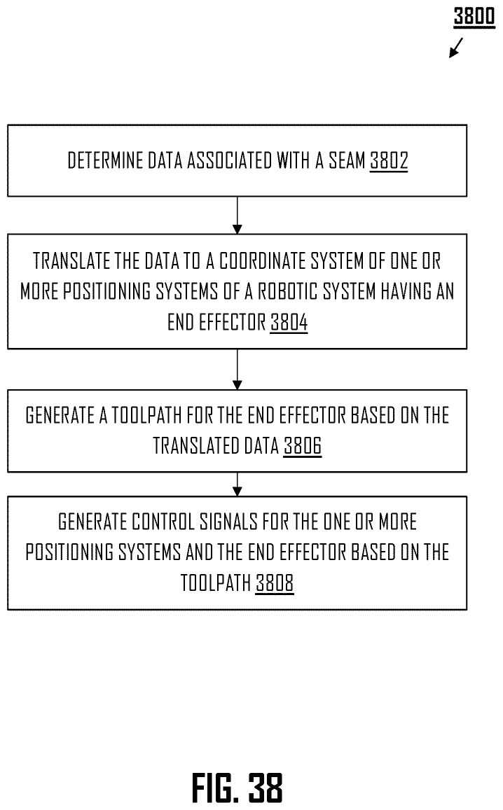

FIG. 38 is a flow diagram illustrating a method for performing targeted application of material, according to some embodiments of the disclosure. In 3802, a perception system (e.g., perception system 320 of FIG. 3) may determine data associated with a seam between two or more components. The data may be determined in part by an algorithm. The data may be in part provided by a user via a user input system. The data associated with the seam can include a location of the seam, and a type of the seam. In 3804, a planner (e.g., planner 340 of FIG. 3) may translate the data associated with the seam from a coordinate system of the perception system to a coordinate system of one or more positioning systems of a robotic system having an end effector. In 3806, the planner may generate a toolpath for the end effector based on the translated data. In 3808, a control system (e.g., control system 350 of FIG. 3) may generate control signals for the one or more positioning systems and the end effector based on the toolpath. In 3808, the control system may control, using the control signals, an end effector positioning system (e.g., one or more positioning systems 306 of FIG. 3) and the end effector (e.g., end effector 116 of various Figures) to cause the end effector to selectively apply a coating to the seam.

In some implementations, surface finishing systems, control systems, perception systems, positioning systems, planners, decision trees, logic, machine learning models, algorithms, software processes, and/or interfaces described herein may include machine-executable code to achieve (or to foster) the functions discussed herein for selective application and/or avoidance of application of material. This could include the implementation of instances of surface finishing systems, control systems, perception systems, positioning systems, planners, interfaces and/or any other suitable element that would foster the activities discussed herein. Additionally, each of these elements can have an internal structure (e.g., a processor, a memory element, etc.) to facilitate some of the operations described herein. In other embodiments, these functions for selective application and/or avoidance of application of material may be executed externally to these elements, or included in some other processing element to achieve the intended functionality. Alternatively, surface finishing systems, control systems, perception systems, positioning systems, planners, and/or interfaces may include machine-executable code (or reciprocating machine-executable code) that can coordinate with other processing elements in order to achieve the selective application and/or avoidance of application of material functions described herein. In still other embodiments, one or several devices may include any suitable algorithms, hardware, software, components, modules, interfaces, or objects that facilitate the operations thereof.

In certain example implementations, the selective application and/or avoidance of application of material functions described herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by one or more processors, or other similar machine, etc.). In some of these instances, one or more memory elements can store data used for the operations described herein. This includes the memory element being able to store instructions (e.g., software, code, etc.) that are executed to carry out the activities described in this Specification. The memory element is further configured to store databases such as mapping databases (mapping various parameters of an end effector to parameters of an applied material) to enable selective application and/or avoidance of application of material as disclosed herein. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of the devices disclosed herein (e.g., the surface finishing systems, base units, robotic arms, etc.) can include memory elements for storing information to be used in achieving the selective application and/or avoidance of application of material, as outlined herein. Additionally, each of these devices may include a processor that can execute software or an algorithm to perform the activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Each of the devices disclosed herein can also include suitable interfaces for receiving, transmitting, and/or otherwise communicating data or information in a network environment.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

### Select Examples

Example 1 is a method as disclosed herein.

Example 2 is a system as disclosed herein.

Example 3 is a method comprising: detecting data corresponding to an object; and selectively applying, based at least in part on the data, a material to the object.

Example 4 is a method comprising: detecting data corresponding to an object; and

selectively avoid applying, based at least in part on the data, a material to the object.

Example 5 is a method comprising: detecting data corresponding to an object; and selectively removing, based at least in part on the data, at least a portion of a material from the object.

Example 6 is a method comprising: detecting data corresponding to an object; and selectively avoid removing, based at least in part on the data, at least a portion of a material from the object.

Example 7 is a computer-readable non-transitory medium comprising instructions, that when executed by at least one processor perform operations of any one of Examples 1, and 3-6.

Example 8 is a system comprising: a base unit comprising: a positioning system to position the base unit, a support coupled to the positioning system, and an optional lift system to control a height of the support; a robotic arm (or other suitable robotic positioning system) comprising a base end and a distal end, the base end coupled to the support; a perception system to detect data associated with an object; and an end effector coupled to the distal end of the robotic arm to selectively apply, based at least in part on the data, a coating to the object.

Example 9 is a system comprising: a base unit comprising: a positioning system to position the base unit, a support coupled to the positioning system, and an optional lift system to control a height of the support; a robotic arm (or other suitable robotic positioning system) comprising a base end and a distal end, the base end coupled to the support; a perception system to detect data associated with an object; and an end effector coupled to the distal end of the robotic arm to selectively remove, based at least in part on the data, at least a portion of a coating (or material of the object) from the object.

Example 10 is a system comprising: a base unit comprising: a positioning system to position the base unit, a support coupled to the positioning system, and an optional lift system to control a height of the support; a robotic arm (or other suitable robotic positioning system) comprising a base end and a distal end, the base end coupled to the support; a perception system to detect data associated with an object; and an end effector coupled to the distal end of the robotic arm to selectively avoid removing, based at least in part on the data, at least a portion of a coating (or material of the object) from the object.

Example 11 is a system comprising: a base unit comprising: a positioning system to position the base unit, a support coupled to the positioning system, and an optional lift system to control a height of the support; a robotic arm (or other suitable robotic positioning system) comprising a base end and a distal end, the base end coupled to the support; a perception system to detect data associated with an object; and an end effector coupled to the distal end of the robotic arm to selectively avoid applying, based at least in part on the data, at least a portion of a coating to the object.

In Example 12, the system of any one of Examples 1 and 8-11 can optionally include the object comprising a seam associated with one or more components.

In Example 13, the system of Examples 12 can optionally include the end effector selectively applying, based at least in part on data about the seam, the coating to the seam. Selecting applying may include the end effector applying the coating on a first portion of the one or more components within a threshold distance of the seam, and the end effector avoiding applying the coating on a second portion of the one or more components outside of the threshold distance of the seam.

In Example 14, the system of Example 12 or 13 can optionally include a control system to translate the data about the seam into a command executable by at least one of the positioning system, the lift system, the robotic arm, the perception system, and the end effector. The command, when executed, can cause the end effector to selectively apply the coating to the seam.

In Example 15, the system of any one of Examples 12-13 can optionally include a planner to generate a plan for selectively applying the coating to an assembly, the assembly comprising the seam associated with one or more components.

In Example 16, the system of any one of Examples 1 and 8-15 can optionally include the assembly including a plurality of seams associated with a plurality of components. The plurality of seams associated with the plurality of components may include the seam associated with the one or more components. The planner can generate the plan by partitioning the assembly into a plurality of partitions, and each of the plurality of partitions includes a subset of the plurality of seams.

In Example 17, the system of Example 16 can optionally include the plurality of partitions comprising: a first partition comprising the seam associated with the one or more components.

In Example 18, the system of any one of Examples 15-17 can optionally include the planner determining a threshold dimension of a maximum work area of the system.

In Example 19, the system of any one of Examples 15-18 can optionally include the planner comprising: a kinematic model of the system, the kinematic model modeling movement of one or more of the positioning system, the support, the optional lift system, the robotic arm, and the end effector.

In Example 20, the system of any one of Examples 15-19 can optionally include the planner determining the threshold dimension of the maximum work area of the system based at least in part on the kinematic model.

In Example 21, the system of any one of Examples 15-20 can optionally include the planner setting a target dimension of each of the plurality of partitions less than or equal to the threshold dimension of the maximum work area of the system.

In Example 22, the system of any one of Examples 15-20 can optionally include the planner determining a target location of the base unit for each of the plurality of partitions. While the base unit is located at the target location, the end effector may reach the plurality of seams within a respective one of the plurality of partitions.

In Example 23, the system of any one of Examples 15-20 can optionally include the planner determining a target location of the base unit for the first partition. While the base unit is located at the target location, the end effector can reach the seam.

In Example 24, the system of any one of Examples 15-20 can optionally include the planner determining a target location of the base unit, wherein the end effector reaches the seam while the base unit is located at the target location.

In Example 25, the system of any one of Examples 22-24 can optionally include the positioning system positioning the base unit within a threshold distance of the target location.

In Example 26, the system of any one of Examples 22-25 can optionally include: a user input system to receive an input confirming that the base unit is within a threshold distance of the target location.

In Example 27, the system of any one of Examples 1 and 8-26 can optionally include a drive system to transmit control input to the positioning system, the control input controlling the positioning system.

In Example 28, the system of Example 27 can optionally include the drive system comprising at least one of a user input device (e.g., lever, joystick, one or more keys, motion capture system), a fully autonomous drive algorithm, and a semi-autonomous drive algorithm.

In Example 29, the system of any one of Examples 12-28 can optionally include a vision system to capture an image including at least a portion of the seam associated with the one or more components.

In Example 30, the system of any one of Examples 12-29 can optionally include a perception system determining an orientation of the one or more components.

In Example 31, the system of any one of Examples 12-30 can optionally include a user input system to receive an input indicative of an orientation of the one or more components.

In Example 32, the system of any one of Examples 12-31 can optionally include: an orientation classifier (e.g., component orientation detection system) to identify an orientation of the one or more components based at least in part on the image. In some cases, the orientation classifier may learn from user input received from a user input system, the user input system to receive an input indicative of an orientation of the one or more components.

In Example 33, the system of Example 32 can include the orientation of the one or more components being one of a plurality of orientations (e.g., either a first orientation or a second orientation).

In Example 34, the system of Example 32 or 33 can optionally include the orientation of the one or more components being either a first angle or a second angle.

In Example 35, the system of any one of Examples 32-34 can optionally include the orientation of the one or more components being either a vertical orientation or a horizontal orientation.

In Example 36, the system of any one of Examples 12-35 can optionally include each of the one or more components has a first dimension and a second dimension, the first dimension and the second dimension being perpendicular to one another, and the first dimension being larger than the second dimension. The first dimension may be vertically aligned when the orientation of the one or more components is the vertical orientation. The first dimension may be horizontally aligned when the orientation of the one or more components is the horizontal orientation.

In Example 37, the system of any one of Examples 12-36 can optionally include a a perception system (e.g., seam data determination system) to determine an orientation of the seam based at least in part on data about the seam.

In Example 38, the system of any one of Examples 12-37 can optionally include a user input system to receive an input indicative of an orientation of the seam.

In Example 39, the system of any one of Examples 12-38 can optionally include a seam classifier (e.g., seam data determination system, seam type identification system) to generate at least a portion of the seam data based at least in part on the image. In some cases, the seam classifier may learn from user input received from a user input system, the user input system to receive an input indicative of an orientation of the seam.

In Example 40, the system of any one of Examples 12-39 can optionally include data about the seam comprising one or more of: a bounding box around the seam, a label identifying an orientation of the seam, a first confidence score associated with the bounding box, a second confidence score associated with the label, and a third confidence score associated with the bounding box and the label.

In Example 41, the system of Example 40 can optionally include a perception system (e.g., a seam data determination system) to determine, based on the seam data, at least two coordinates corresponding to points along a centerline of the seam.

In Example 42, the system of Example 41 can optionally include the least two coordinates corresponding to endpoints of a centerline of the seam.

In Example 43, the system of any one of Examples 12-42 can optionally include the orientation of the seam being either a first orientation or a second orientation.

In Example 44, the system of any one of Examples 12-43 can optionally include the orientation of the seam being either a first angle or a second angle.

In Example 45, the system of any one of Examples 12-44 can optionally include the orientation of the seam is either a vertical orientation or a horizontal orientation.

In Example 46, the system of any one of Examples 12-45 can optionally include the seam having a first dimension and a second dimension, the first dimension and the second dimension being perpendicular to one another, and the first dimension being larger than the second dimension. The first dimension can be vertically aligned when the orientation of the seam is the vertical orientation. The first dimension can be horizontally aligned when the orientation of the seam is the horizontal orientation.

In Example 47, the system of any one of Examples 12-46 can optionally include a perception system to determine a profile of one or more edges of the one or more components.

In Example 48, the system of any one of Examples 12-47 can optionally include a user input system to receive an input indicative of a profile of one or more edges of the one or more components.

In Example 49, the system of any one of Examples 12-48 can optionally include a profile classifier (e.g., part of an edge type identification system) to generate data representative of a profile of one or more edges of the one or more components. The profile classifier may learn from user input received from a user input system, the user input system to receive an input indicative of a profile of one or more edges of the one or more components.

In Example 50, the system of any one of Examples 47-49 can optionally include the profile comprising a location of a tapered edge of the one or more components, and a location of a flat (e.g., non-tapered) edge of the one or more components.

In Example 51, the system of any one of Examples 47-50 can optionally include the profile comprising: a tapered edge around an entire perimeter of the one or more components, and a flat (e.g., non-tapered) edge around the entire perimeter of the one or more components.

In Example 52, the system of any one of Examples 12-51 can optionally include each of the one or more components having a first dimension and a second dimension, the first dimension and the second dimension being perpendicular to one another, and the first dimension being larger than the second dimension. Each of the one or more components can include: a tapered edge located on a first edge that is parallel to the first dimension; and a flat edge located on a second edge that is parallel to the second dimension;

In Example 53, the system of any one of Examples 12-52 can optionally include a perception system (e.g., a seam type identification system) to determine a type of the seam based on a combination of: the orientation of the seam, the orientation of the one or more components, and data representative of the profile of one or more edges of the one or more components.

In Example 54, the system of Example 53 can optionally include the type comprising a first type and a second type.

In Example 55, the system of Example 54 can optionally include the first type being a butt seam formed by flat edges of adjacent ones of the one or more components, and the second type being a tapered seam formed by tapered edges of adjacent ones of the one or more components.

In Example 56, the system of any one of Examples 12-55 can optionally include a perception system (e.g., an edge type identification system) to determine, based on the data representative of the profile, that a tapered edge is located on a first edge that is parallel to a first dimension of the one or more components; and determine, based on the data representative of the profile, that a flat edge is located on a second edge that is parallel to a second dimension of the one or more components.

In Example 57, the system of any one of Examples 30-56 can optionally include determining the orientation of the one or more components comprising: determining that the first dimension of the one or more components is in a vertical orientation; and determining that the second dimension of the one or more components is in a horizontal orientation.

In Example 58, the system of Example 57 can optionally include the perception system (e.g., a seam type identification system) determining that the seam is a first type based on the orientation of the seam being the vertical orientation and the first dimension of the one or more components being in the vertical orientation; and determining that the seam is a second type based on the orientation of the seam being the horizontal orientation and the second dimension of the one or more components being in the horizontal orientation.

In Example 59, the system of any one of Examples 12-58 can optionally include a user input system to receive an input to change a type of the seam. The input can change a type of the seam from a first type to a second type. In some cases, a seam type identification system may learn from the user input received from the user input system.

In Example 60, the system of any one of Examples 1 and 8-59 can optionally include a memory storing a coordinate system relative to the base unit; the perception system collecting positional data relating the one or more components to the coordinate system; a camera capturing an image of the one or more components, and the memory storing a location of the camera in the coordinate system. The planner may translate at least one pixel of the image to a point in the coordinate system based at least in part on the location of the camera in the coordinate system.

In Example 61, the system of Example 60 can optionally include the end effector selectively applying the coating to the seam comprising applying the coating to the point in the coordinate.

In Example 62, the system of any one of Examples 1 and 8-61 can optionally include the end effector applying the coating in an elliptical pattern.

In Example 63, the system of any one of Examples 1 and 8-62 can optionally include the system angling the end effector to set the width of a sprayed coating.

In Example 64, the system of any one of Examples 1 and 8-63 can optionally include the perception system being coupled to at least one of the base unit, the robotic arm, and the end effector.

Example 65 is a robotic system for performing targeted application of material, the robotic system comprising: a base unit comprising: a ground positioning system to position the base unit, and a support coupled to the positioning system, an end effector positioning system comprising a first portion and a second portion, the first portion coupled to the support; an end effector coupled to the second portion of the end effector positioning system; a perception system to detect data associated with a seam between two or more components; a planner to generate a plan for the end effector based on the data; and a control system to generate control signals based on the plan for one or more of the ground positioning system, the end effector positioning system, and the end effector to cause the end effector to selectively apply a coating to the seam.

In Example 66, the robotic system of Example 65 can optionally include the end effector selectively applying the coating to the seam comprising: the end effector applying the coating on a first portion of the one or more components within a threshold distance of the seam, and the end effector avoiding applying the coating on a second portion of the one or more components outside of the threshold distance of the seam.

In Example 67, the robotic system of Example 65 or 66 can optionally include the robotic system further including a vision system to capture an image including at least a portion of the seam; and the perception system detecting the data associated with the seam based on the image.

In Example 68, the robotic system of any one of Examples 65-67 can optionally include: the perception system comprising a seam data determination system; and the seam data determination system determining the data associated with the seam, wherein the data includes a bounding box around the seam, a label identifying an orientation of the seam, optionally a first confidence score associated with the bounding box, optionally a second confidence score associated with the label, and optionally a third confidence score associated with the bounding box and the label.

In Example 69, the robotic system of any one of Examples 65-68 can optionally include the perception system having: a component orientation detection system to detect orientation of the components; and a seam type identification system detects a seam type based on the detected orientation of the components.

In Example 70, the robotic system of any one of Examples 65-69 can optionally include the robotic system being communicably coupled to a user input system; the user input system to receive user input identifying an orientation of the components; and the perception system having a seam type identification system that detects a type of the seam based on the received user input identifying the orientation of the components.

In Example 71, the robotic system of any one of Examples 65-70 can optionally include: the robotic system being communicably coupled to a user input system; the user input system to receive user input indicative of a location of the seam, an orientation of the seam and the type of the seam; and the perception system detecting the data associated with the seam based on the user input.

In Example 72, the robotic system of any one of Examples 65-71 can optionally include: the data associated with the seam being determined based on an image capturing at least a portion of seam; the planner determining, based on data associated with the seam, two coordinates in the image corresponding to endpoints of the seam; and the planner translating the two coordinates in the image into coordinates of a three-dimensional coordinate system of the robotic system.

In Example 73, the robotic system of Example 72 can optionally include the control system generating the control signals based on the coordinates of the three-dimensional coordinate system corresponding to endpoints of the seam to cause the end effector to apply the coating on the seam.

In Example 74, the robotic system of any one of Examples 65-73 can optionally include: the robotic system being communicably coupled to a user input system; and the user input system to receive an input indicative of an orientation of the components.

In Example 75, the robotic system of any one of Examples 65-74 can optionally include: the robotic system being communicably coupled to a user input system; and the user input system to receive an input indicative of an orientation of the seam.

In Example 76, the robotic system of any one of Examples 65-75 can optionally include: the robotic system being communicably coupled to a user input system; and the user input system to receive an input indicative of a type of the seam.

In Example 77, the robotic system of any one of Examples 65-76 can optionally include: the robotic system being communicably coupled to a user input system; and the user input system to receive an input changing a location of the seam.

In Example 78, the robotic system of any one of Examples 65-77 can optionally include: the robotic system being communicably coupled to a user input system; and the user input system to receive an input changing a length of the seam.

In Example 79, the robotic system of any one of Examples 65-78 can optionally include: the robotic system being communicably coupled to a user input system; and the user input system to receive an input changing an orientation of the seam.

In Example 80, the robotic system of any one of Examples 65-79 can optionally include: the robotic system being communicably coupled to a user input system; and the user input system to receive an input changing a type of the seam.

In Example 81, the robotic system of any one of Examples 65-80 can optionally include the robotic system being communicably coupled to a user input system; and the user input system to receive user input indicative of the data associated with the seam and/or the components; the perception system including a machine learning model that outputs data about the seam and/or the components; and the received user input being used to further train, correct, and/or calibrate the machine learning model.

In Example 82, the robotic system of any one of Examples 65-81 can optionally include: the end effector being controlled by the control signals generated by the control system to selectively apply a further coating using a fan bias angle that is 180 degrees offset from a fan bias angle used with the coating.

In Example 83, the robotic system of any one of Examples 65-82 can optionally include: the end effector comprising two spray nozzles, selectively controllable to apply material onto a surface; the control signals causing a first one of the spray nozzles to apply the coating; and the control signals causing a second one of the spray nozzles to apply a further coating.

Example 84 is a method for performing targeted application of material, the method comprising: determining, by a perception system, data associated with a seam between two or more components, wherein the data associated with the seam includes a location of the seam, and a type of the seam; translating the data associated with the seam from a coordinate system of the perception system to a coordinate system of one or more positioning systems of a robotic system having an end effector; generating a toolpath for the end effector based on the translated data; and generating control signals for the one or more positioning systems and the end effector based on the toolpath; controlling, using the control signals, an end effector positioning system and the end effector to cause the end effector to selectively apply a coating to the seam.

Example 85 is a computer-readable non-transitory medium comprising instructions, that when executed by at least one processor perform operations of Example 84 or any one of the methods described herein.

What is claimed is:

1. A robotic system for performing targeted application of material, the robotic system comprising:
a base unit comprising:
a ground positioning system to position the base unit, and
a support coupled to the ground positioning system,
an end effector positioning system comprising a first portion and a second portion, the first portion coupled to the support;
an end effector coupled to the second portion of the end effector positioning system;
a perception system to detect data associated with a seam between two or more components;
a planner to generate a plan for the end effector based on the data; and
a control system to generate control signals based on the plan for one or more of the ground positioning system, the end effector positioning system, and the end effector to cause the end effector to selectively apply a coating to the seam.

2. The robotic system of claim 1, wherein the end effector selectively applying the coating to the seam comprises:
the end effector applying the coating on a first portion of the one or more components within a threshold distance of the seam, and
the end effector avoiding applying the coating on a second portion of the one or more components outside of the threshold distance of the seam.

3. The robotic system of claim 1, wherein:
the robotic system further includes a vision system to capture an image including at least a portion of the seam; and
the perception system detects the data associated with the seam based on the image.

4. The robotic system of claim 1, wherein:
the perception system comprises a seam data determination system; and
the seam data determination system determines the data associated with the seam, wherein the data includes a bounding box around the seam, a label identifying an orientation of the seam, optionally a first confidence score associated with the bounding box, optionally a second confidence score associated with the label, and optionally a third confidence score associated with the bounding box and the label.

5. The robotic system of claim 1, wherein the perception system has:
a component orientation detection system to detect orientation of the components; and
a seam type identification system detects a seam type based on the detected orientation of the components.

6. The robotic system of claim 1, wherein:
the robotic system is communicably coupled to a user input system;
the user input system is to receive user input identifying an orientation of the components; and
the perception system has a seam type identification system that detects a type of the seam based on the received user input identifying the orientation of the components.

7. The robotic system of claim 1, wherein:
the robotic system is communicably coupled to a user input system;
the user input system is to receive user input indicative of a location of the seam, an orientation of the seam and a type of the seam; and
the perception system detects the data associated with the seam based on the user input.

8. The robotic system of claim 1, wherein:
the data associated with the seam is determined based on an image capturing at least a portion of seam;
the planner determines, based on data associated with the seam, two coordinates in the image corresponding to endpoints of the seam; and
the planner translates the two coordinates in the image into coordinates of a three-dimensional coordinate system of the robotic system.

9. The robotic system of claim 8, wherein:
the control system generates the control signals based on the coordinates of the three-dimensional coordinate system corresponding to endpoints of the seam to cause the end effector to apply the coating on the seam.

10. The robotic system of claim 1, wherein:
the robotic system is communicably coupled to a user input system; and
the user input system is to receive an input indicative of an orientation of the components.

11. The robotic system of claim 1, wherein:
the robotic system is communicably coupled to a user input system; and
the user input system is to receive an input indicative of an orientation of the seam.

12. The robotic system of claim 1, wherein:
the robotic system is communicably coupled to a user input system; and
the user input system is to receive an input indicative of a type of the seam.

13. The robotic system of claim 1, wherein:
the robotic system is communicably coupled to a user input system; and
the user input system is to receive an input changing a location of the seam.

14. The robotic system of claim 1, wherein:
the robotic system is communicably coupled to a user input system; and
the user input system is to receive an input changing a length of the seam.

15. The robotic system of claim 1, wherein:
the robotic system is communicably coupled to a user input system; and
the user input system is to receive an input changing an orientation of the seam.

16. The robotic system of claim 1, wherein:
the robotic system is communicably coupled to a user input system; and
the user input system is to receive an input changing a type of the seam.

17. The robotic system of claim 1, wherein:
the robotic system is communicably coupled to a user input system; and
the user input system is to receive user input indicative of the data associated with the seam and/or the components;
the perception system includes a machine learning model that outputs data about the seam and/or the components; and
the received user input is used to further train, correct, and/or calibrate the machine learning model.

18. The robotic system of claim 1, wherein the end effector is controlled by the control signals generated by the control system to selectively apply a further coating using a fan bias angle that is 180 degrees offset from a fan bias angle used with the coating.

19. The robotic system of claim 1, wherein:
the end effector comprises two spray nozzles, selectively controllable to apply material onto a surface;
the control signals cause a first one of the spray nozzles to apply the coating; and
the control signals cause a second one of the spray nozzles to apply a further coating.

20. A method for performing targeted application of material, the method comprising:
determining, by a perception system, data associated with a seam between two or more components, wherein the data associated with the seam includes a location of the seam, and a type of the seam;
translating the data associated with the seam from a coordinate system of the perception system to a coordinate system of one or more positioning systems of a robotic system having an end effector;
generating a toolpath for the end effector based on the translated data;
generating control signals for the one or more positioning systems and the end effector based on the toolpath; and
controlling, using the control signals, an end effector positioning system and the end effector to cause the end effector to selectively apply a coating to the seam.
